(19) United States
(12) Patent Application Publication
(10) Pub. No.: US 2024/0218109 A1
(43) Pub. Date: Jul. 4, 2024

(54) LIGNIN-DERIVED AND PERFORMANCE-ENHANCED NON-ISOCYANATE POLYURETHANE THERMOSETS

(71) Applicants: Sampanna V. Mhatre, Newark, DE (US); Jignesh S. Mahajan, Newark, DE (US); Thomas H. Epps,, III, Bear, DE (US); LaShanda T. J. Korley, Middletown, DE (US)

(72) Inventors: Sampanna V. Mhatre, Newark, DE (US); Jignesh S. Mahajan, Newark, DE (US); Thomas H. Epps,, III, Bear, DE (US); LaShanda T. J. Korley, Middletown, DE (US)

(73) Assignee: University of Delaware, Newark, DE (US)

(21) Appl. No.: 18/540,190

(22) Filed: Dec. 14, 2023

Related U.S. Application Data
(60) Provisional application No. 63/432,517, filed on Dec. 14, 2022.

(51) Int. Cl. C08G 18/44; C08G 18/08; C08G 18/18

(52) U.S. Cl. CPC C08G 18/44; C08G 18/0852; C08G 18/1875

(57) ABSTRACT

Disclosed herein are bio-derivable polyhydroxyurethanes, methods of making them, compositions comprising the same, and articles comprising such compositions. The bio-derivable polyhydroxyurethane comprises in polymerized form at least one polymerizable lignin-derivable cyclic carbonate monomer, and one or more polymerizable amine crosslinkers, each comprising two or more primary amines, such that at least one of the one or more polymerizable amine crosslinkers comprises three primary amines. The bio-derivable polyhydroxyurethanes display enhanced mechanical performance as compared to the petroleum-derived analogues.

### CROSS-REFERENCE TO RELATED APPLICATION

This application claims priority to U.S. Provisional Patent Application No. 63/432,517, filed Dec. 14, 2022, the disclosure of which is being incorporated herein by reference in its entirety for all purposes.

### STATEMENT REGARDING FEDERALLY SPONSORED RESEARCH

This invention was made with government support under Grant No. NSF DMR POL 2004682 awarded by the National Science Foundation. The government has certain rights in the invention.

### BACKGROUND OF THE INVENTION

Polyurethanes (PUs) are a class of thermoplastic (linear chain) or thermosetting (crosslinked) polymers with numerous uses including building and industrial insulation, cars, furniture, clothing, and shoes—and as coatings, sealants, and adhesives. Given these various applications, PUs rank 6th in global polymer production, with more than 70 wt % of PUs employed as thermosetting materials. Yet, PUs are primarily manufactured from petroleum feedstocks, and only about 1% of the total global PU production was biobased as of 2020. Additionally, the synthesis of PUs typically involves the use of hazardous isocyanates. Two of the most common thermosetting PU precursors, methylene diphenyl diisocyanate (MDI) and toluene diisocyanate (TDI), are considered carcinogenic, mutagenic, and reprotoxic, and extended exposure to isocyanates can lead to other severe health concerns, such as asthma, dermatitis, conjunctivitis, and acute poisoning. Moreover, most isocyanates are manufactured from toxic and hazardous phosgene gas. Compounding these toxicity and potential non-renewability considerations, waste thermoset PUs at their end of lives are either incinerated or land-filled, releasing toxins and depleting land resources with a few exceptions, such as the utilization of PU foam mattresses for soil-free food production.

To address the challenges associated with isocyanates, non-isocyanate polyurethanes (NIPUs), e.g., poly(hydroxyurethanes), have emerged as more benign alternatives to traditional PUs. Typical NIPU thermosets are synthesized by reacting multifunctional cyclic carbonates and amines (as opposed to multifunctional isocyanates and diols in traditional PUs), which leads to pendant hydroxyl groups adjacent to the urethane linkages in the NIPU polymer backbone. These additional hydroxyl units can enhance the thermomechanical properties and also impart reprocessability to NIPU thermosets through associative transcarbomylation. The thermomechanical properties of these polymeric systems are governed by the nature of the building blocks. For example, aromatic isocyanates (TDI/MDI) provide the required rigidity to networks for high-performance applications, while aliphatic building blocks offer weather and ultraviolet light resistance. Although NIPU thermosets derived from biobased feedstocks have been reported in the literature (Carre et al., ChemSusChem, 2019, 12, 3410-3430 (“Carre”); Haniffa et al., Chem Asian J, 2021, 16, 1281-129; and Ghasemlou et al., Eur. Polym. J., 2019, 118, 668-684), many of these approaches have been primarily limited to aliphatic/cycloaliphatic, bifunctional or multifunctional cyclic carbonates derived from soybean oil (Salanti et al., RSC Adv., 2017, 7, 25054-25065; and Dong et al., Polym. Chem., 2020, 11, 7524-7532 (“Dong”)), linseed oil (Bähr et al., Green Chem., 2012, 14, 483-489), glycerol, pentaerythritol, trimethylolpropane (Fleischer et al., Green Chem., 2013, 15, 934-942) or limonene (Tamami et al., J. Appl. Polym. Sci., 2004, 92, 883-891). The aliphatic or cycloaliphatic backbones present in most biobased NIPUs result in thermosets with relatively low moduli and tensile strengths. In contrast, petroleum-based bisphenol A (BPA)-derived cyclic carbonate (BPACC), prepared from the dicarbonation of BPA diglycidyl ether (BADGE), is often employed to make higher-moduli NIPU networks. Unfortunately, BPA is considered non-sustainable and is a suspected endocrine disruptor, as it can potentially bind to estrogen receptors. Thus, there is a significant need to find and utilize non-toxic, biobased, aromatic building blocks that structurally resemble BPA (or MDI) and can be useful as precursors in NIPU thermosets.

Lignin is a high-volume renewable source of aromatic building blocks, and it can be deconstructed to yield a broad range of substituted phenols that then can be converted into bisphenols through traditional chemical approaches. Moreover, these lignin-derivable bisphenols (particularly bisguaiacols/bissyringols) possess lower estrogenic activity in comparison to petroleum-derived BPA and bisphenol F (BPF) due to the methoxy groups that restrict access to estrogen receptors. These bisguaiacols/bissyringols have been studied as replacements for BPA/BPF in epoxy-amine networks, wherein the relative number of methoxy substituents, and their regioisomers on the aromatic ring impacted the glass transition temperatures (T_{g}s) and storage moduli of the thermosets (Nicastro et al., ACS Sustain. Chem. Eng., 2018, 6, 14812-14819 (“Nicastro”); Hernandez et al., ACS Sustain. Chem. Eng., 2016, 4, 4328-4339 (“Hernandez”); and Llevot et al., Macromol. Rapid Commun., 2016, 37, 9-28). Lignin-derivable syringaresinol dicyclic carbonate crosslinked with tris(2-aminoethyl) amine (TREN) also has been investigated as an alternative to a BPA-based NIPU network (Janvier et al., ACS Sustain. Chem. Eng., 2017, 5, 8648-8656). The bio-derivable NIPU had a T_{g} of approximately 62° C. that was comparable to a TREN-cured BPACC control. However, in these studies, application-significant tensile properties (e.g., toughness, elongation at break [ε_{b}], and tensile strength at yield [σ_{y}]) were not explored. Overall, there is a need for a systematic design and evaluation of lignin-derivable NIPU networks that are structurally similar to petroleum-based bisaromatic NIPUs.

### SUMMARY OF THE INVENTION

Disclosed herein are lignin-derivable cyclic carbonates for non-isocyanate polyurethane (NIPU) thermoset formation with enhanced toughness as compared to the petroleum-derived analogues. Moreover, the lignin-derivable NIPU thermosets retained other application-specific properties that were similar to those of petroleum-based counterparts such as, but not limited to, thermal stability, tensile strength, and elastic modulus.

In an aspect of the present invention, there is provided a bio-derivable polyhydroxyurethane comprising in polymerized form:
a) at least one polymerizable lignin-derivable cyclic carbonate monomer having a structure corresponding to formula (I), formula (II), or formula (III):

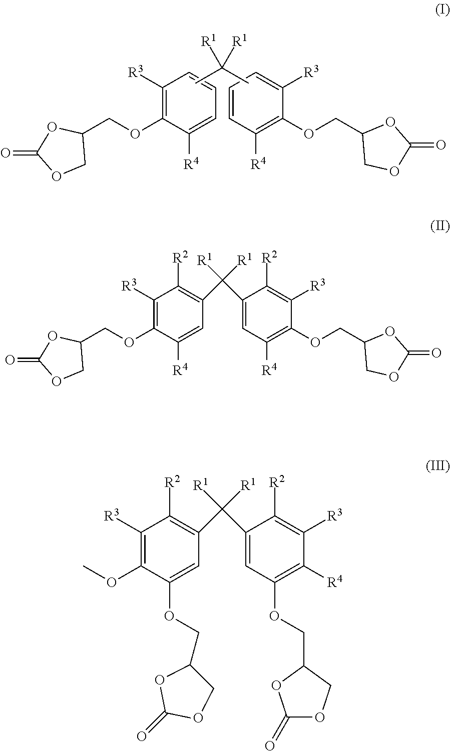

wherein:
   (i) each R¹ is independently a hydrogen or a methyl group, and
   (ii) each R² is independently a hydrogen, a C1-C3 alkyl, a C1-C2 alkoxy, or an allyl group,
   (iii) each R³ is independently a hydrogen or a methyl group, and
   (iv) each R⁴ is independently a hydrogen, a C1-C3 alkyl, or a C1-C2 alkoxy group; and
(b) one or more polymerizable amine crosslinkers, each comprising two or more primary amines, such that at least one of the one or more polymerizable amine crosslinkers comprises three primary amines.

In an embodiment of the bio-derivable polyhydroxyurethane, the polymerizable lignin-derivable cyclic carbonate monomer is derived from bisguaiacol A, bisguaiacol F, bisguaiacol P, bisguaiacol S, bissyringol A, bissyringol F, regioisomers thereof, and mixtures thereof.

In another embodiment, the at least one polymerizable lignin-derivable cyclic carbonate monomer has one of the following structures:

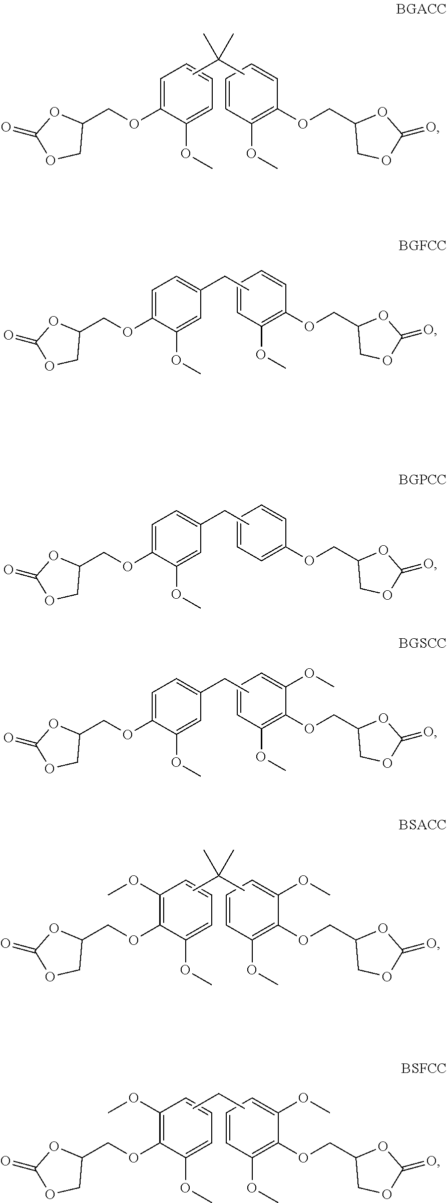

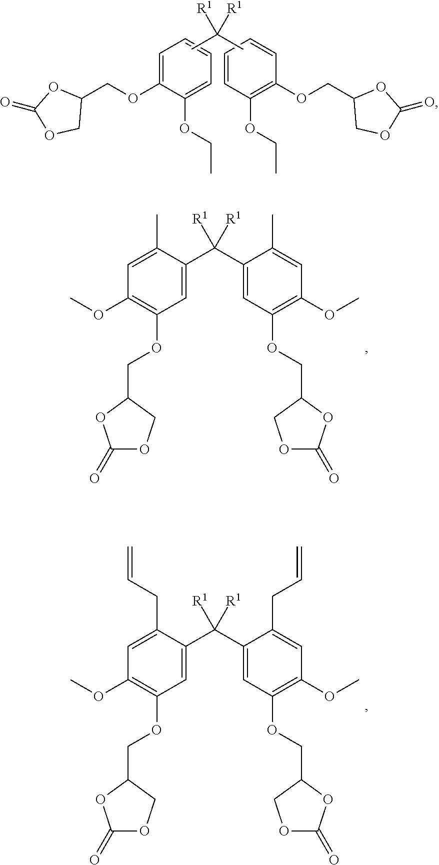

regioisomers thereof, or mixtures thereof,

wherein each R¹ is as defined as hereinabove.

In another embodiment, each of the one or more polymerizable amine crosslinkers independently has a structure corresponding to formula (IV):

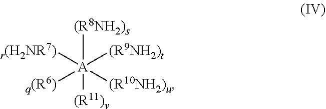

wherein:
(i) A is independently a nitrogen atom, a carbon atom, a phenyl ring, or a cyclohexyl ring,
(ii) each of q, r, s, t, u, and v is independently 0 or 1, such that:
   a. if A is a nitrogen atom, a phenyl ring, or a cyclohexyl ring, then q+r+s+t+u+v=3 and r+s+t+u=2 or 3, and
   b. if A is a carbon atom, then q+r+s+t+u+v=4, and r+s+t+u=2 or 3 or 4,
(iii) each R⁶ and R¹¹ is independently a hydrogen, a C1-C10 alkyl group, a C4-C9 alicyclic group, or a C5-C50 polyalkylene ether group containing at least one oxygen atom between any two carbon atoms of the alkylene chain, where the alkyl and polyalkylene ether groups can be unbranched or branched,
(iv) each R⁷, R⁸, R⁹, and R¹⁰ is independently a bond (i.e., C₀), a C1-C50 alkylene group, a C6-C12 arylene group, a C4-C9 bivalent alicyclic group, or a C5-C50 polyalkylene ether group containing at least one oxygen atom between any two carbon atoms of the alkylene chain, where the alkylene and polyalkylene ether groups can be unbranched or branched.

In yet another embodiment, the one or more polymerizable amine crosslinker has one of the following structures:

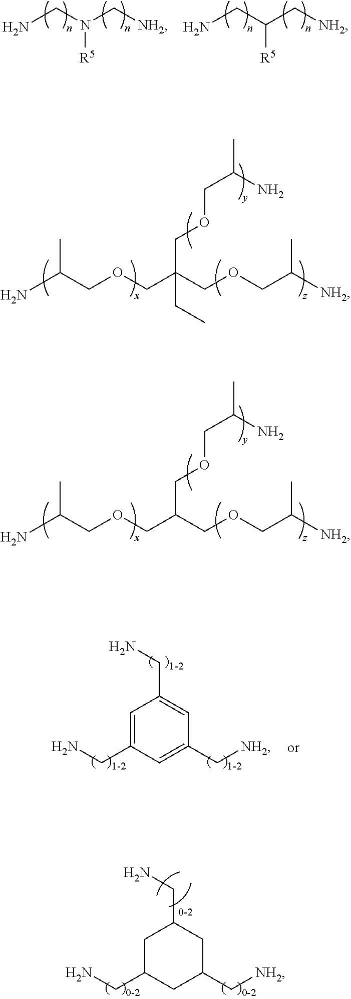

wherein R⁵═H or

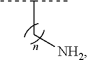

n=1-5, and each of x, y, and z is independently in a range of 1-47, such that x+y+z is in a range of 5-50.

In an aspect of the bio-derivable polyhydroxyurethane, the one or more polymerizable amine crosslinkers comprises a mixture of a first polymerizable amine crosslinker comprising three or four primary amine groups and a second polymerizable amine crosslinker comprising two primary amine groups.

In an embodiment, the bio-derivable polyhydroxyurethane as disclosed hereinabove comprises a portion of a crosslinked structure corresponding to formula (V), formula (VI), or formula (VII):

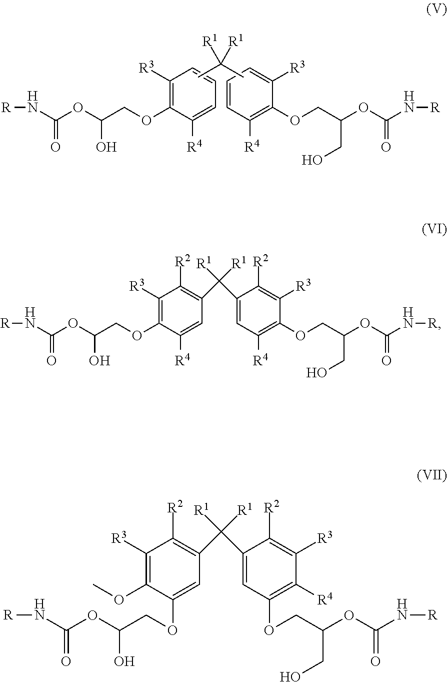

wherein each R¹, R², R³, and R⁴ is defined as hereinabove, and each R independently comprises an amine cross-linker containing partially or fully crosslinked amine groups. In an embodiment, the two Rs are the same. In another embodiment, the two Rs are different.

In an embodiment, each —NH—R of formula (V), formula (VI), or formula (VIII) independently represents a portion of the crosslinked structure, comprising partially or fully crosslinked amine groups of the amine crosslinker, and each —NH—R independently has the following formula (VIII):

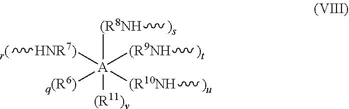

wherein:
(i) each A, q, r, s, t, u, v, R⁶, R⁷, R⁸, R⁹, R¹⁰, and R¹¹ is defined as in formula (IV), and
(ii) [symbol] represents where the crosslinked structure (VIII) is either covalently bonded via a NH group to formula (V), formula (VI), or formula (VII) (i.e. crosslinked), or [symbol] represents covalent bond to hydrogen atom (i.e. a NH₂ group with no crosslinking), with the proviso that at least two of R⁷, R⁸, R⁹, and R¹⁰ are bonded such that the bio-derivable polyhydroxyurethane is crosslinked.

In as aspect, there is provided a bio-derivable polyhydroxyurethane, wherein the bio-derivable polyhydroxyurethane further comprises in polymerized form:
(i) the at least one polymerizable lignin-derivable cyclic carbonate monomer having a structure corresponding to formula (I), formula (II), or formula (III), regioisomers, or mixtures thereof,
(ii) the one or more polymerizable amine crosslinkers each comprising two or more primary amines, each having a structure corresponding to formula (IV), such that at least one of the one or more polymerizable amine crosslinkers comprises three primary amines, and
(iii) a non-lignin-derived cyclic carbonate comonomer.

In an embodiment of the bio-derivable polyhydroxyurethane, as disclosed hereinabove, the non-lignin-derived cyclic carbonate comonomer is derived from at least one of 2,2′-diallylbisphenol A, bisphenol A, bisphenol F, bisphenol S, 2,2′-biphenol, 4,4′-biphenol, multiphenol and/or hydroquinone.

In another embodiment of the bio-derivable polyhydroxyurethane, the polymerizable lignin-derivable cyclic carbonate monomer and the one or more polymerizable amine crosslinkers are present in a molar ratio of 1:0.5 to 1:1.

In various embodiments, the bio-derivable polyhydroxyurethane as disclosed hereinabove has (i) a toughness in a range of 0.1 to 25 MJ/m³ and yield strength in a range of 30 to 100 (or more) MPa, or (ii) a toughness in a range of 25 to 100 (or more) MJ/m³ and yield strength in a range of 0.1 to 30 MPa.

In an aspect, there is a composition comprising the bio-derivable polyhydroxyurethane as disclosed hereinabove. In an embodiment, the composition comprises one or more additives selected from the group consisting of tackifiers, plasticizers, viscosity modifiers, photoluminescent agent, anti-counterfeit and UV-reactive additives, dyes/pigments, anti-static materials, surfactants, and lubricants.

In another aspect, there is an article comprising the composition as disclosed hereinabove. In an embodiment, the article is a coated surface, a packaging, a rigid foam, a flexible foam, an elastomer, an artificial leather, a microelectronic component, an underwater cable, a printed circuit board, a composite wood product, a fiber-reinforced composite, an adhesive, or a sealant.

In another aspect, there is a method of preparing the bio-derivable polyhydroxyurethane as disclosed hereinabove. The method comprises providing a first solution comprising at least one polymerizable lignin-derivable cyclic carbonate monomer having the structure corresponding to formula (I), formula (II), or formula (III) in a first solvent and providing a second solution comprising the one or more polymerizable amine crosslinkers, having a structure corresponding to formula (IV), in a second solvent, wherein each of the one or more polymerizable amine crosslinkers comprises two or more primary amines, such that at least one of the one or more polymerizable amine crosslinkers comprises three primary amines. The method further comprises contacting the first solution with the second solution at a temperature in a range of 50 to 110° C. for an amount of time in a range of 16 to 96 hours to form the bio-derivable polyhydroxyurethane, wherein the at least one polymerizable lignin-derivable cyclic carbonate monomer and the one or more polymerizable amine crosslinkers are present in a molar ratio of 1:0.5 to 1:1.

In an embodiment, the method further comprises post-curing under vacuum at a temperature in the range of 70 to 100° C. for an amount of time in a range of 16 to 96 hours.

In another embodiment of the method, the first and the second solvent are independently selected from dimethylformamide, 2-methyl tetrahydrofuran, γ-valerolactone, cyrene, dimethylsulfoxide, tetrahydrofuran, and dimethylacetamide.

In some embodiments of the method, the step of providing a first solution comprises forming the polymerizable lignin-derivable cyclic carbonate monomer comprising the steps of contacting an excess molar amount of guaiacol, syringol, or syringyl alcohol with acetone or vanillyl alcohol in the presence of an acid catalyst at a temperature in the range of 60 to 120° C. for an amount of time in a range of 2 to 24 hours to form at least one of bisguaiacol or bissyringol and contacting at least one of bisguaiacol or bissyringol with an excess molar amount of epichlorohydrin in the presence of a catalyst to form a diglycidyl ether. The method further comprises carbonating the diglycidyl ether with an excess molar amount of carbon dioxide in the presence of the catalyst at a temperature in the range of 80 to 150° C. and at a pressure of 20 to 30 bar for an amount of time in a range of 12 to 24 hours to form a cyclic carbonate having the structure corresponding to formula (I), formula (II), or formula (III).

In some other embodiments of the method, the catalyst comprises tetrabutylammonium bromide, tetrabutylammonium iodide.

### BRIEF DESCRIPTION OF THE DRAWINGS

FIG. 1 shows a synthetic scheme for preparing of lignin-derivable bisguaiacols, diglycidyl ethers, and cyclic carbonates: (a) condensation of guaiacol and acetone to give bisguaiacol A (BGA); (b) reaction between vanillyl alcohol and guaiacol to give bisguaiacol F (BGF); and (c) glycidylation of bisguaiacols to form diglycidyl ethers, followed by carbonation to give cyclic carbonates, wherein (i) is 0.1 mol tetrabutylammonium bromide (TBAB), argon (Ar), 50° C. for 2 h, and (ii) is 4 mol sodium hydroxide (NaOH, aq, 40 wt %), 50° C. for 18 h.

FIG. 2 shows a synthetic scheme for preparing NIPU thermosets, and molecular structures of exemplary cyclic carbonates and triamines: (a) reaction of bifunctional cyclic carbonates with trifunctional amines to form NIPU thermosets, where (i) is N,N-dimethylformamide (DMF), 100° C. for 72 h; (b) molecular structures of cyclic carbonates, wherein the lignin-derivable compounds (on the right) have one methoxy group both on the right-most and the left-most aromatic ring (1,1), the petroleum-derived analogues on the left have no methoxy group on either ring (0,0), the compounds on top have a dimethyl-substituted bridging carbon (Me), and the bottom compounds have an unsubstituted bridging carbon (Un); and (c) molecular structures of trifunctional amines used as curing agents.

FIG. 3 shows a proton (¹H) Nuclear Magnetic Resonance (NMR) (600 MHZ) spectrum for bisguaiacol A in deuterated dimethyl sulfoxide (DMSO-d₆)

FIG. 4 shows a ¹H NMR (600 MHZ) spectrum for bisguaiacol F in DMSO-d₆.

FIG. 5 shows a ¹H NMR (600 MHZ) spectrum of bisphenol A diglycidyl ether (BADGE) in DMSO-d₆.

FIG. 6 shows a ¹H NMR (600 MHZ) spectrum of bisguaiacol A diglycidyl ether (BGADGE) in DMSO-d₆.

FIG. 7 shows a ¹H NMR (600 MHZ) spectrum of bisphenol F diglycidyl ether (BFDGE) in DMSO-d₆.

FIG. 8 shows a ¹H NMR (600 MHZ) spectrum of bisguaiacol F diglycidyl ether (BGFDGE) in DMSO-d₆.

FIG. 9 shows a ¹H NMR (600 MHZ) spectrum of bisphenol A cyclic carbonate (BPACC) in DMSO-d₆.

FIG. 10 shows a ¹H NMR (600 MHZ) spectrum of bisguaiacol A cyclic carbonate (BGACC) in DMSO-d₆.

FIG. 11 shows a ¹H NMR (600 MHZ) spectrum of bisphenol F cyclic carbonate (BPFCC) in DMSO-d₆.

FIG. 12 shows a ¹H NMR (600 MHZ) spectrum of bisguaiacol F cyclic carbonate (BGFCC) in DMSO-d₆.

FIG. 13 shows photographs of non-isocyanate polyurethane (NIPU) networks using BPACC, BGACC, BPFCC, and BGFCC, and (a) crosslinked by tris(2-aminoethyl) amine (TREN), and (b) crosslinked by JEFFAMINE® T-403 (T403). The NIPUs were formed by the reaction of bifunctional cyclic carbonates and trifunctional amines dissolved in N,N-dimethylformamide. The reaction mixtures were cured in air at 60° C. for 2 h, then at 80° C. for 2 h, followed by 100° C. for 20 h, and subsequently post-cured under vacuum at 100° C. for 48 h.

FIG. 14 shows stacked Fourier Transform Infrared (FTIR) spectra of (a) BPACC, BPACC-TREN, and BPACC-T403, and (b) BGACC, BGACC-TREN, and BGACC-T403. The conversion was monitored qualitatively by the disappearance of the cyclic carbonate carbonyl stretching band at approximately 1790 cm⁻¹ (highlighted), the appearance of the urethane carbonyl stretching band at approximately 1700 cm⁻¹ (highlighted), and the appearance of the hydroxyl stretching band at approximately 3500-3300 cm⁻¹. Curves are shifted vertically for clarity.

FIG. 15 shows stacked FTIR spectra of (a) BPFCC, BPFCC-TREN, and BPFCC-T403, and (b) BGFCC, BGFCC-TREN, and BGFCC-T403. The conversion was monitored qualitatively by the disappearance of the cyclic carbonate carbonyl stretching band at approximately 1790 cm⁻¹ (highlighted), the appearance of the urethane carbonyl stretching band at approximately 1700 cm⁻¹ (highlighted), and the appearance of the hydroxyl stretching band at approximately 3500-3300 cm⁻¹. Curves are shifted vertically for clarity.

FIG. 16 shows representative DSC second heating traces of (a) TREN-based thermosets and (b) T403-based NIPU thermosets (10° C./min, N₂). Curves are shifted vertically for clarity with T_{g} values marked on the respective curves. Each tick mark on the y-axis represents a 0.1 W/g increment.

FIG. 17 shows T_{g} as a function of the number of methoxy groups on the rings with the type of bridging-carbon substitution as bar labels for (a) TREN-based NIPU thermosets and (b) T403-based NIPU thermosets. Error bars indicate standard deviations of the measurements.

FIG. 18 shows representative differential scanning calorimetry (DSC) first cooling traces of (a) TREN-based and (b) T403-based NIPU networks (10° C./min under an N₂ atmosphere). Curves are shifted vertically for clarity with T_{g} values marked on the respective curves. Each tick mark on the y-axis represents a 0.2 W/g increment.

FIG. 19 shows representative thermogravimetric analysis traces and the respective first-derivative curves of sample mass remaining versus temperature for (a) TREN-based and (b) T403-based NIPU thermosets obtained at a heating rate of 10° C./min in an N₂ atmosphere.

FIG. 20 shows storage modulus and tan δ as a function of temperature for (a) TREN-based and (b) T403-based NIPU thermosets. Data shown are from the second heating cycle of Dynamic Mechanical Analysis (DMA) experiments, in oscillatory film tension mode at a heating rate of 3° C./min, strain amplitude of 0.3%, frequency of 0.1 Hz, and an axial force of 0.4 N.

FIG. 21 shows representative engineering tensile stress versus engineering strain of (a) TREN-based NIPU thermosets and (b) T403-based NIPU thermosets obtained from uniaxial tensile testing using a load cell of 100 N and an extension rate of 10 mm/min at about 20° C.

FIG. 22 shows (a) toughness, (b) ε_{b}, and (c) σ_{y} as a function of the number of methoxy groups on the rings with the bridging-carbon substitution as bar labels.

FIG. 23 shows deconvoluted FTIR —OH and —NH stretching bands of (a) BPACC/BGACC-T403 and (b) BPFCC/BGFCC-T403 NIPU thermosets, (c) estimated percent hydrogen-bonding as a function of the number of methoxy groups on the rings with the type of bridging-carbon substitution as bar labels.

### DETAILED DESCRIPTION OF THE INVENTION

As used herein, the term “polyhydroxyurethane” is used interchangeably with “non-isocyanate polyurethane,” which is abbreviated as NIPU, and “NIPU thermoset.”

As used herein, the term “bio-derivable,” as used in “bio-derivable polyhydroxyurethane” and “bio-derivable NIPU” refers to a polyurethane that can be derived from at least one lignin-based monomer.

As used herein, the term “lignin-based monomer” refers to a chemical compound that is at least partially derived from lignin-containing biomass, including, but not limited to, softwoods, lignocellulose biomass, solid wood waste, forest wood waste, lignin rich food waste, energy crops, animal waste, agricultural waste, or lignin residue generated by cellulosic biorefinery or paper pulping industries. Suitable lignin-rich food wastes include, but are not limited to, nutshells, olive seeds, and tomato peels and seeds. Suitable energy crops include, but are not limited to, wheat, corn, soybean, sugarcane, arundo, camelina, carinate, jatropha, miscanthus, sorghum, and switchgrass. As used herein, the term “lignin-based monomer” may be partly derived from petrochemical resources.

Suitable examples of lignin-containing biomass include, for example and without limitation, oak, alder, chestnut, ash, aspen, balsa, beech, birch, boxwood, walnut, laurel, camphor, chestnut, cherry, dogwood, elm, eucalyptus, pear, hickory, ironwood, maple, olive, poplar, sassafras, rosewood, bamboo, coconut, locust, and willow trees, as well as, but not limited to, grasses (e.g., switchgrass, bamboo, straw), cereal crops (e.g., barley, millet, wheat), agricultural residues (e.g., corn stover, bagasse), and lignin-rich food wastes (e.g., nutshells, olive seeds, tomato peels and seeds).

Assessment of the renewably based carbon in a material can be performed through standard test methods. Using radiocarbon and isotope ratio mass spectrometry analysis, the bio content of materials can be determined, using ASTM-D6866 a standard method established by ASTM International, formally known as the American Society for Testing and Materials.

As used herein, the “bio content” or “bio-mass content” of the bio-derivable polyhydroxyurethane is determined in accordance with ASTM-D6866 and is based on the same concepts as radiocarbon dating, but without use of the age equations. The analysis is performed by deriving a ratio of the amount of radiocarbon (¹⁴C) in an unknown sample to that of a modern reference standard. The ratio is reported as a percentage with the units “pMC” (percent modern carbon) with modern or present defined as 1950. If the material being analyzed is a mixture of present-day radiocarbon and fossil carbon (containing no radiocarbon), then the pMC value obtained correlates directly to the amount of biomass material present in the sample.

Combining fossil carbon with present day carbon into a material will result in a dilution of the present day pMC content. By presuming that 107.5 pMC represents present day biomass materials and 0 pMC represents petroleum derivatives, the measured pMC value for that material will reflect the proportions of the two component types. For example, a material derived 100% from present day plant/tree would give a radiocarbon signature near 107.5 pMC. If that material were diluted with 50% petroleum derivatives, it would give a radiocarbon signature near 54 pMC.

A bio-mass content result is derived by assigning 100% equal to 107.5 pMC and 0% equal to 0 pMC. In this regard, a sample measuring 99 pMC will give an equivalent bio content result of 93%.

As used herein, the term “lignin-derivable bisguaiacols” and “lignin-derivable bissyringols” are used interchangeably with “lignin-derivable BPA alternatives,” “lignin-derivable BPA analogues,” “lignin-derivable BPA equivalents,” “bio-derivable bisguaiacols,” “bio-derivable BPA alternatives,” “bio-derivable BPA analogues,” and “bio-derivable BPA equivalents,” and refers to bisguaiacols and/or bissyringols that are at least partially derived from lignin-containing biomass.

As used herein, the term “non-lignin derived” is used interchangeably with “petroleum-derived” and refers to compounds that are derived from petrochemical resources.

As used herein, the phrase “a bisphenol equivalent of a lignin-derived monomer” is used interchangeably with “a bisphenol analogue of a lignin-derived monomer” and refers in particular to a petroleum-derived bisphenol having a structure similar to an ortho-alkoxy bisphenol, which is a lignin-derived monomer, except that petroleum-derived bisphenol does not include an ortho-methoxy group on each phenyl group, as present in the lignin-derivable monomer. For example, as used herein, petroleum-derived BPA is equivalent to or analogue of lignin-derivable BGA and petroleum-derived BPF is equivalent to or analogue of lignin-derivable BGF and vice versa.
BPA

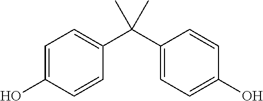 [SMILES: CC(C)(c1ccc(O)cc1)c1ccc(O)cc1]

is equivalent to or analogue of BGA

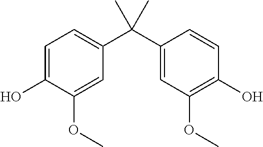 [SMILES: COc1cc(C(C)(C)c2ccc(O)c(OC)c2)ccc1O]

BPF

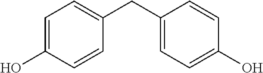 [SMILES: Oc1ccc(Cc2ccc(O)cc2)cc1]

is equivalent to or analogue of BGF

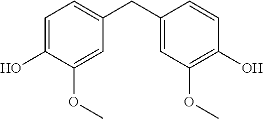 [SMILES: COc1cc(Cc2ccc(O)c(OC)c2)ccc1O]

Hence, as used herein, the term “petroleum-derived analogues” refer to petroleum-derived BPA- and/or BPF-based cyclic carbonates, which are equivalent to or analogues of bisguaiacols-based cyclic carbonates, BGA- and BPF-based cyclic carbonates respectively, as summarized below:
BPACC(0,0)(Me)

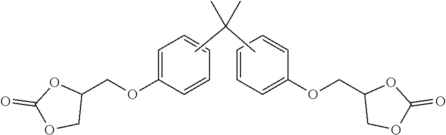

is equivalent to or analogue of
BGACC(1,1)(Me)

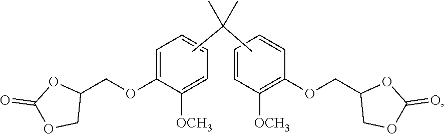

and
BPFCC(0,0)(Un)

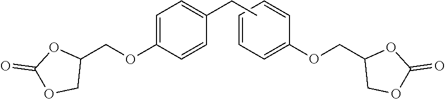

is equivalent to or analogue of
BGFCC(1,1)(Un)

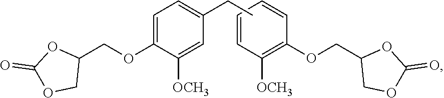

wherein (1,1) refers to methoxy groups; and (Me) refers to dimethyl substitution and (Un) refers to no substitution.

Disclosed herein are bio-derivable polyhydroxyurethanes, methods of making them, compositions comprising the same, and articles comprising such compositions. Also, disclosed herein are the thermal and mechanical behavior of these novel bio-derivable polyhydroxyurethanes in comparison to the petroleum-derived BPA- and BPF-based polyhydroxyurethanes, prepared the same manner.

In an aspect of the present invention, disclosed herein is a bio-derivable polyhydroxyurethane comprising in polymerized form at least one polymerizable lignin-derivable cyclic carbonate monomer having a structure corresponding to formula (I), formula (II), or formula (III), regioisomers, or mixtures thereof, and one or more polymerizable amine crosslinkers, each comprising two or more primary amines, such that at least one of the one or more polymerizable amine crosslinkers comprises three primary amines.

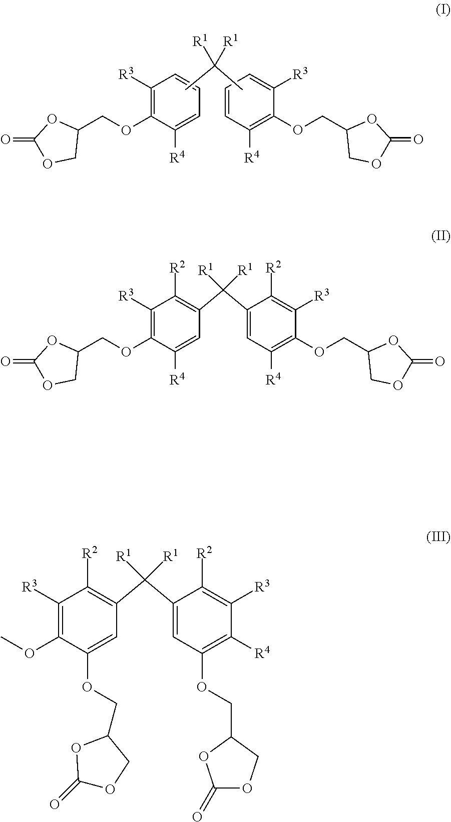

wherein:
(i) each R¹ is independently a hydrogen or a methyl group, and
(ii) each R² is independently a hydrogen, a C1-C3 alkyl, a C1-C2 alkoxy, or an allyl group,
(iii) each R³ is independently a hydrogen or a methyl group, and
(iv) each R⁴ is independently a hydrogen, a C1-C3 alkyl, or a C1-C2 alkoxy group.

In an embodiment, the at least one polymerizable lignin-derivable cyclic carbonate monomer is derived from bisguaiacol A, bisguaiacol F, bisguaiacol P, bisguaiacol S, bissyringol A, bissyringol F, regioisomers, and mixtures thereof. Some examples of the cyclic carbonates of formula (I), formula (II), and formula (III), and corresponding bisguaiacols and bissyringols from which they are derived are summarized below:

| | Corresponding bisguaiacols and |
|---|---|
| Substituents in the cyclic carbonates having | bissyringols from which the cyclic |
| formula (I), formula (II), or formula (III) and | carbonates having Formula (I), formula |
| corresponding cyclic carbonates: | (II), or formula (III) are derived from: |
| R¹ = CH₃; R², R³ = H; and R⁴ = OCH₃ | bisguaiacol A (BGA) |
| 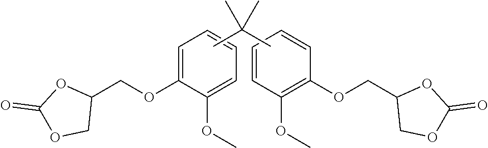 | 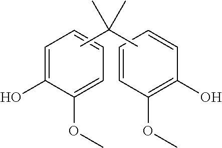 |
| BGACC | BGA |
| R¹, R², R³ = H; and R⁴ = OCH₃ | bisguaiacol F (BGF) |
| 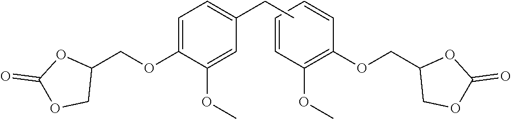 | 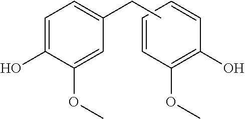 |
| BGFCC | BGF |
| R¹, R², R³, R⁴ = H | bisguaiacol P (BGP) |
| 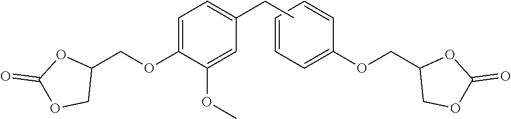 | 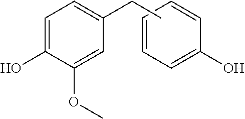 |
| BGPCC | BGP |
| R¹, R² = H; R³ = H, OCH₃; and R⁴ = OCH₃ | bisguaiacol S (BGS) |
| 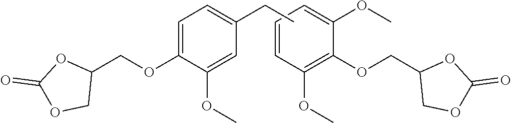 | 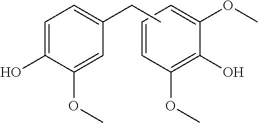 |
| BGSCC | BGS |
| R¹ = CH₃; R² = H; and R³, R⁴ = OCH₃ | bissyringol A (BSA) |
| 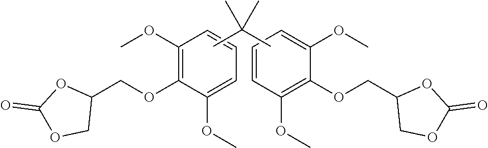 | 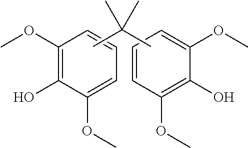 |
| BSACC | BSA |
| R¹, R² = H; and R³, R⁴ = OCH₃ | Bissyringol F (BSF) |
| 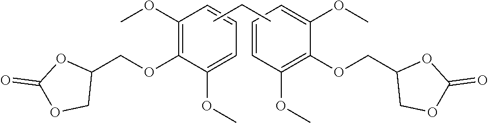 | 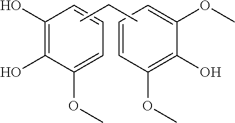 |
| BSFCC | BSF |

Suitable examples of the at least one polymerizable lignin-derivable cyclic carbonate monomer from the above bisguaiacols and bissyringols include, but are not limited to, the following chemical structures:

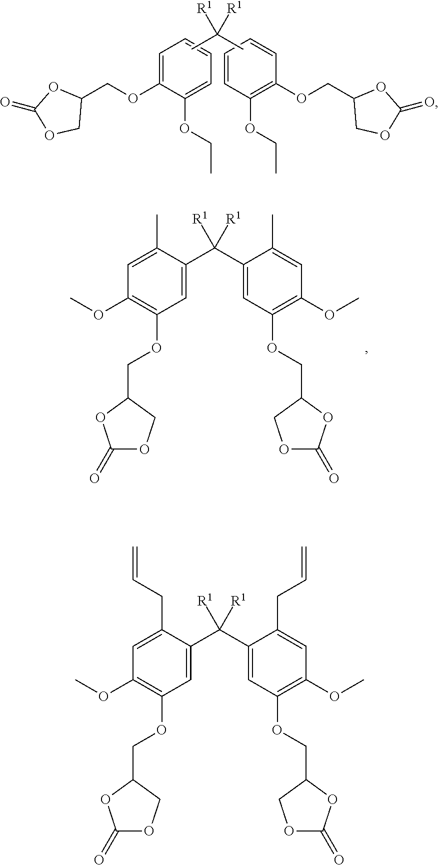

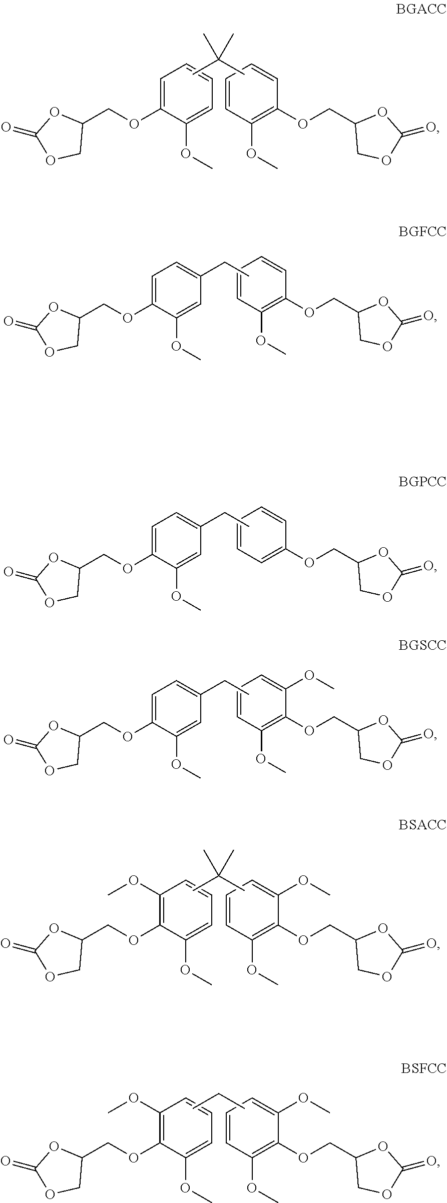

regioisomers, or mixtures thereof,
wherein each R¹ is as defined hereinabove.

In an embodiment of the bio-derivable polyhydroxyurethane disclosed hereinabove, each of the one or more polymerizable amine crosslinkers independently has a structure corresponding to formula (IV):

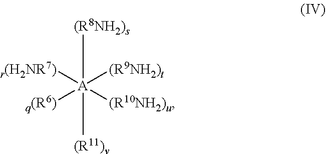

wherein:
(i) A is independently a nitrogen atom, a carbon atom, a phenyl ring, or a cyclohexyl ring,
(ii) each of q, r, s, t, u, and v is independently 0 or 1, such that:
   a. if A is a nitrogen atom, a phenyl ring, or a cyclohexyl ring, then q+r+s+t+u+v=3 and r+s+t+u=2 or 3, and
   b. if A is a carbon atom, then q+r+s+t+u+v=4, and r+s+t+u=2, 3, or 4,
(iii) each R⁶ and R¹¹ is independently a hydrogen, a C1-C10 alkyl group, a C4-C9 alicyclic group, or a C5-C50 polyalkylene ether group containing at least one oxygen atom between any two carbon atoms of the alkylene chain, where the alkyl and polyalkylene ether groups can be unbranched or branched,
(iv) each R⁷, R⁸, R⁹, and R¹⁰ is independently a bond (i.e., Co), a C1-C50 alkylene group, a C6-C12 arylene group, a C4-C9 bivalent alicyclic group, or a C5-C50 polyalkylene ether group containing at least one oxygen atom between any two carbon atoms of the alkylene chain, where the alkylene and polyalkylene ether groups can be unbranched or branched.

Suitable alkyl groups include, for example, straight-chain or branched C1-C10-alkyl groups, or C1-C7-alkyl groups, or C1-C5-alkyl groups, or C1-C3-alkyl groups. These include, but are not limited to, methyl, ethyl, propyl, isopropyl, n-butyl, 2-butyl, sec-butyl, tert-butyl, n-pentyl, 2-pentyl, 2-methylbutyl, 3-methylbutyl, 1,2-dimethylpropyl, 1,1-dimethylpropyl, 2,2-dimethylpropyl, 1-ethylpropyl, n-hexyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, n-heptyl, 2-heptyl, 3-heptyl, 2-ethylpentyl, 1-propylbutyl, etc.

Suitable alkylene groups include, for example, straight-chain or branched C1-C10-alkylene groups, or C1-C7-alkylene groups, or C1-C5-alkylene groups, or C1-C3-alkylene groups. These include, but are not limited to, methylene, ethylene, propylene, isopropylene, n-butylene, 2-butylene, sec-butylene, tert-butylene, n-pentylene, 2-pentylene, 2-methylbutylene, 3-methylbutylene, 1,2-dimethylpropylene, 1,1-dimethylpropylene, 2,2-dimethylpropylene, 1-ethylpropylene, n-hexylene, 2-hexylene, 2-methylpentylene, 3-methylpentylene, 4-methylpentylene, 1,2-dimethylbutylene, 1,3-dimethylbutylene, 2,3-dimethylbutylene, 1,1-dimethylbutylene, 2,2-dimethylbutylene, 3,3-dimethylbutylene, 1,1,2-trimethylpropylene, 1,2,2-trimethylpropylene, 1-ethylbutylene, 2-ethylbutylene, 1-ethyl-2-methylpropylene, n-heptylene, 2-heptylene, 3-heptylene, 2-ethylpentylene, 1-propylbutylene, etc.

The number of carbon atoms in the arylene group of the amino crosslinker is not particularly limited, and is preferably in the range of C6-C12, or C6-C9, or C6-C7. Suitable examples of “arylene group” include, but are not limited to, phenylene, and bivalent tolyl, xylyl, mesityl, naphthyl, fluorenyl, anthracenyl, phenanthrenyl, naphthacenyl rings, and in particular phenylene and bivalent tolyl, xylyl, or mesityl rings. The arylalkyl group of the amino crosslinker refers to any aryl derivative of the alkyl group, as defined hereinabove.

The alicyclic group of the amino crosslinker is not particularly limited and may contain one or more all-carbon rings which may be either saturated or unsaturated, but do not have aromatic character. The number of carbon atoms in the alicyclic group may be in the range of C4-C9, or C4-C8, or C5-C6. Suitable examples of alicyclic group include, but are not limited to, bivalent C5-C8-cycloalkyl, such as cyclopentyl, cyclohexyl, cycloheptyl or cyclooctyl rings.

The polyalkylene ether group is not particularly limited and may carbon atoms in the range of C5-50, or C5-C48, or C5-C32, or C5-C16. The polyether group may have a number-average molecular weight in the range of at least 440 g/mol, or at least 1000 g/mol, at least 2000 g/mol, or at least 3000 g/mol.

Suitable examples of the one or more polymerizable amine crosslinkers include, but are not limited to, one of the following structures:

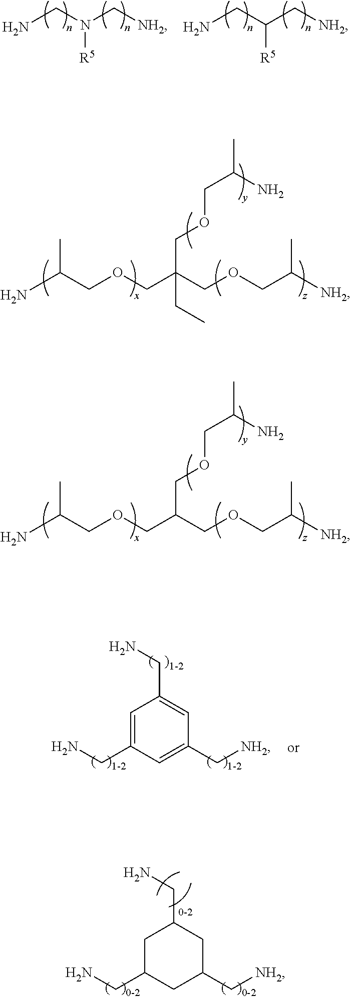

wherein R⁵═H or

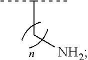

n=1-5; each of x, y, and z is independently in a range of 1-47, or 1-18, or 1-16, such that x+y+z is in a range of 5-50, or 5-32, or 5-16.

In an embodiment, the one or more polymerizable amine crosslinkers comprises a tri-, and/or a tetra-functional monomer(s) containing two or more, such as three or more, such as four or more primary amine groups. In another embodiment, the one or more polymerizable amine crosslinkers comprises a combination of, bi-/tri-, bi-/tetra-, tri-/tri-, tri-/tetra-, tetra-/tetra-, bi-/bi-/tri-, bi-/bi-/tetra-, bi-/tri-/tri-, bi-/tetra-/tetra-, bi-/tri-/tetra-, tri-/tri-/tri-, tri-/tri-/tetra-, tri-/tetra-/tetra-, or tetra-/tetra-/tetra-functional amino monomers or any other suitable combinations, where each monomer contains two or more, such as three or more, such as four or more primary amine groups. In one embodiment, the one or more polymerizable amine crosslinkers comprises a mixture of a first polymerizable amine crosslinker comprising three or four primary amine groups and a second polymerizable amine crosslinker comprising two primary amine groups.

In an embodiment of the bio-derivable polyhydroxyurethane, the polymerizable lignin-derivable cyclic carbonate monomer and the one or more polymerizable amine crosslinkers are present in a molar ratio of 1:0.51 to 1:1, or 1:0.55 to 1:1, or 1:0.6 to 1:1, or 1:0.65 to 1:1.

In one embodiment, the bio-derivable polyhydroxyurethane, as disclosed hereinabove comprises a portion of a crosslinked structure corresponding to the following formula (V), formula (VI), or formula (VII):

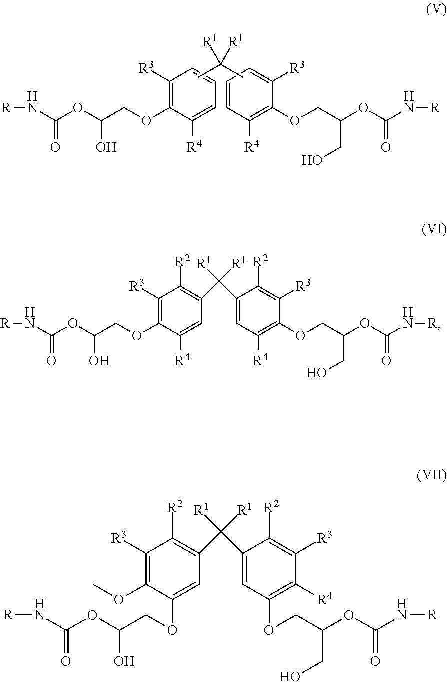

wherein:
(i) each R¹, R², R³, and R⁴ is defined as hereinabove, and
(ii) each R independently comprises an amine cross-linker containing partially or fully crosslinked amine groups. In an embodiment, the two Rs are the same. In another embodiment, the two Rs are different.

In an embodiment, each —NH—R in formula (V), formula (VI), or formula (VII) independently represents a portion of the crosslinked structure, comprising partially or fully crosslinked amine groups of the amine cross-linker of formula (IV); each —NH—R independently has the following formula (VIII):

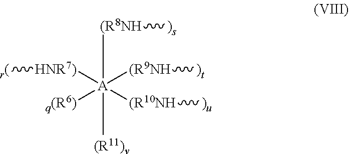

wherein each A, q, r, s, t, u, v, R⁶, R⁷, R⁸, R⁹, R¹⁰, and R¹¹ is defined hereinabove for formula (IV), and [symbol] represents wherein the crosslinked structure (VIII) is either covalently bonded via a NH group to formula (V), formula (VI), or formula (VII) (i.e. crosslinked) or [symbol] represents covalent bond to hydrogen atom (i.e. a NH₂ group with no crosslinking), with the proviso that at least two of R⁷, R⁸, R⁹, and R¹⁰ are bonded such that the bio-derivable polyhydroxyurethane is crosslinked.

In an embodiment of the bio-derivable polyhydroxyurethane, as disclosed hereinabove, each —NH—R of formula (V), formula (VI), or formula (VII) has a structure corresponding to formula (IX):

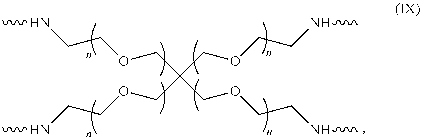

wherein n=1-5.

In an aspect of the bio-derivable polyhydroxyurethane, the polymerizable lignin-derivable cyclic carbonate monomer is a mixture of lignin-derivable cyclic carbonate monomer and a non-lignin-derived cyclic carbonate comonomer. Any suitable comonomer may be added to tune one or more properties of the resulting polyhydroxyurethane, such as, thermal, mechanical, solvent resistance, etc., properties.

In an embodiment, the bio-derivable polyhydroxyurethane comprises in polymerized form (i) at least one polymerizable lignin-derivable cyclic carbonate monomer having a structure corresponding to formula (I), formula (II), or formula (III), regioisomers thereof, or mixtures thereof, (ii) one or more polymerizable amine crosslinkers each independently having a structure corresponding to formula (IV), such that at least one of the one or more polymerizable amine crosslinkers comprises three primary amines, and (iii) a non-lignin-derived cyclic carbonate comonomer.

In another embodiment, the non-lignin-derived cyclic carbonate comonomer contains two or more phenol rings. In yet another embodiment, the non-lignin-derived cyclic carbonate comonomer is a phenol equivalent of the lignin-derivable cyclic carbonate monomer, including, but not limited to, bisphenol A and bisphenol F. Suitable examples of non-lignin-derived cyclic carbonate comonomers include cyclic carbonates derived from at least one of 2,2′-diallylbisphenol A, bisphenol A, bisphenol F, bisphenol S, 2,2′-biphenol, 4,4′-biphenol, multiphenol, and/or hydroquinone.

The relative molar ratios of the lignin-derivable cyclic carbonate monomer and the non-lignin-derived cyclic carbonate comonomer can vary substantially. In an embodiment, a total amount of the lignin-derivable cyclic carbonate monomer and the non-lignin-derived cyclic carbonate comonomer, and the one or more polymerizable amine crosslinkers are present in a molar ratio of 1:0.51 to 1:1, or 1:0.55 to 1:1, or 1:0.6 to 1:1, or 1:0.65 to 1:1. In an embodiment, the molar fraction of the lignin-derivable cyclic carbonate monomer relative to its bisphenol equivalent, i.e. the petroleum derived cyclic carbonate, is in the range of 1.0 to 0.001, or 0.95 to 0.05, or 0.90 to 0.10. In another embodiment, the molar fraction of the lignin-based monomer relative to the comonomer is in the range of 1.0 to 0.001, or 0.95 to 0.05, or 0.90 to 0.10. In another embodiment, the non-lignin-derived cyclic carbonate comonomer is present in a molar amount of less than 50% of the total amount of the lignin-derivable cyclic carbonate monomer and the non-lignin-derived cyclic carbonate comonomer.

Any suitable method can be used to synthesize the bio-derivable polyhydroxyurethanes as disclosed hereinabove. In an embodiment, the method comprises providing a first solution comprising at least one polymerizable lignin-derivable cyclic carbonate monomer having the structure corresponding to formula (I), formula (II), or formula (III) in a first solvent. The method also comprises providing a second solution comprising the one or more polymerizable amine crosslinkers, having a structure corresponding to formula (IV), in a second solvent, wherein each of the one or more polymerizable amine crosslinkers comprises two or more primary amines, such that at least one of the one or more polymerizable amine crosslinkers comprises three primary amines. The method further comprises contacting the first solution with the second solution and curing at a temperature in a range of 50 to 110° C., or 60 to 105° C., or 70 to 100° C. for an amount of time in a range of 10 to 100 hours, or 15 to 95 hours, or 16 to 96 hours in air to form the bio-derivable polyhydroxyurethane, wherein the at least one polymerizable lignin-derivable cyclic carbonate monomer and the one or more polymerizable amine crosslinkers are present in a molar ratio of 1:0.51 to 1:1, or 1:0.55 to 1:1, or 1:0.6 to 1:1, or 1:0.65 to 1:1.

In an embodiment, the curing is performed in air by stepwise increase in the temperature in two or more steps and then curing at a temperature in the range of 90-110° C. In an embodiment, curing is performed in air at a temperature in the range of 50-70° C. for 1-3 h, followed by curing at a temperature in the range of 75-90° C., 1-3 h, and then final curing at a temperature in the range of 95-110° C., 10-30 h. The method may further comprise post-curing under vacuum at a temperature in the range of 80 to 110° C. for 40-60 h, such as for example at post-curing under vacuum at 100° C. for 45-50 h.

Any suitable first solvent and second solvent may be used. In an embodiment, the first and the second solvents are independently selected from dimethylformamide, 2-methyl tetrahydrofuran, γ-valerolactone, cyrene, dimethylsulfoxide, tetrahydrofuran, and dimethylacetamide. In an embodiment, the first and the second solvent are the same. In another embodiment, the first and the second solvent are different.

The step of providing a first solution may further comprise a step of forming the polymerizable lignin-derivable polymerizable lignin-derivable cyclic carbonate monomer comprising contacting an excess molar amount of guaiacol, syringol, or syringyl alcohol with acetone or vanillyl alcohol in the presence of an acid catalyst at a temperature in the range of 60 to 120° C. for an amount of time in a range of 2 to 24 hours to form at least one of bisguaiacol or bissyringol and contacting at least one of bisguaiacol or bissyringol with an excess molar amount of epichlorohydrin in the presence of a catalyst to form a diglycidyl ether. The method further includes a step of carbonating the diglycidyl ether with an excess molar amount of carbon dioxide in the presence of the catalyst at a temperature in the range of 80 to 150° C. and at a pressure of 20 to 30 bar for an amount of time in a range of 12 to 24 hours to form a cyclic carbonate having the structure corresponding to formula (I), formula (II), or formula (III). Any suitable catalyst may be used, such as for example, a catalyst comprising tetrabutylammonium bromide and/or tetrabutylammonium iodide.

While not intending to be bound by any theory, it is believed that, and as experimentally shown in the examples below, the glass transition temperature of the bio-derivable polyhydroxyurethane can be tuned by choosing the polymerizable lignin-derivable cyclic carbonate monomer from formula (I), formula (II), or formula (II) where R² and R³ are methoxy groups (1, 1) and/or R¹ having bridging methyl groups, and triamines of different chain lengths. In particular, methoxy groups reduce T_{g}, while methyl groups at bridging carbons increase T_{g} by reducing rotational freedom. Also, by changing the carbon chain length of the amine crosslinker to a shorter carbon chain can increase the T_{g}. Additionally, the mechanical properties of the bio-derivable polyhydroxyurethane can be tuned from rigid and high-strength to tough and flexible by changing the carbon chain length of the amine crosslinkers.

In an embodiment, the bio-derivable polyhydroxyurethane as disclosed hereinabove, has a toughness in a range of 0.1 to 25 MJ/m³, or 0.1 to 15 MJ/m³, or 0.1 to 10 MJ/m³, or 0.1 to 5 MJ/m³, and a yield strength in a range of at least 30 MPa, or at least 50 MPa, or at least 60 MPa, or at least 80 MPa, or at least 100 MPa. In another embodiment, the bio-derivable polyhydroxyurethane, as disclosed hereinabove, has a toughness in a range of at least 20 MJ/m³, or at least 50 MJ/m³, or at least 75 MJ/m³, or at least 100 MJ/m³, and a yield strength in a range of 0.1 to 50 MPa, or 1 to 48 MPa, or 15 to less than 50 MPa, or 20 to less than 48 MPa.

In an embodiment, the bio-derivable polyhydroxyurethanes, as disclosed hereinabove have a toughness of about 60-80% higher than those of similar polyhydroxyurethanes obtained from bisphenol A/bisphenol F-based analogues.

In another embodiment, the bio-derivable polyhydroxyurethanes, as disclosed hereinabove have a substantially similar thermal degradation onset temperature of 5 percent weight loss to those of similar polyhydroxyurethane derived from petroleum-derived analogues such as from bisphenol A/bisphenol F-based analogues. In an embodiment, the bio-derivable polyhydroxyurethanes have thermal degradation onset temperature of 5 percent weight loss that is within 1-5% of that of the petroleum-derived analogues.

In yet another embodiment, the bio-derivable polyhydroxyurethanes, as disclosed hereinabove have a substantially similar elastic modulus to those of similar polyhydroxyurethane derived from petroleum-derived analogs, such as from bisphenol A/bisphenol F-based analogues. In an embodiment, the bio-derivable polyhydroxyurethanes, as disclosed hereinabove have elastic modulus value within 10% of that of the petroleum-derived analogues.

In some other embodiments, the bio-derivable polyhydroxyurethanes, as disclosed hereinabove have a substantially similar tensile strength at yield to those of similar polyhydroxyurethane derived from bisphenol A/bisphenol F-based analogues. In an embodiment, the bio-derivable polyhydroxyurethanes, as disclosed hereinabove have tensile strength at yield value within 1-5% of that of the petroleum-derived analogues.

In some other embodiments, the bio-derivable polyhydroxyurethanes, as disclosed hereinabove have around 50-60% higher extent of hydrogen bonding than similar polyhydroxyurethane derived from petroleum-derived analogues, such as from bisphenol A/bisphenol F-based analogues.

As shown in the examples below, bisguaiacol/bisphenol-derived cyclic carbonates with variations in methoxy content and bridging-carbon substitution were cured with triamines of different chain lengths, and the impact of these differences on the thermomechanical properties of NIPU networks is significant. It has been found that the methoxy groups present in the lignin-derivable cyclic carbonate monomers led to bio-derivable polyhydroxyurethane thermosets with significantly improved toughness (approximately 49-59 MJ/m³) and elongation at break (ε_{b}, approximately 195-278%) vs. the BPA/BPF-based benchmarks (toughness approximately 26-35 MJ/m³, ε_{b} approximately 86-166%). Furthermore, the addition of dimethyl substitution on the bridging carbon resulted in increased yield strength (σ_{y})—from approximately 28 MPa for networks with unsubstituted bridging carbons to about 45 MPa for the dimethyl-substituted materials. These enhancements to mechanical properties were achieved while retaining essential thermoset properties, such as application-relevant moduli and thermal stabilities. Finally, the triamine crosslinkers provided substantial tunability of thermomechanical properties and produced NIPUs that ranged from rigid materials with a high yield strength (σ_{y}, approximately 65-88 MPa) to flexible and tough networks. Overall, the structure-property relationships presented herein highlight a promising framework for the design of versatile, bio-derivable, NIPU thermosets.

In an embodiment, a calculated bio-mass content of the bio-derivable polyhydroxyurethanes is in a range of 65-92 pMC and thereby 60-85%, by considering weight% of the lignin-derivable cyclic carbonate in the thermoset and assigning 100% being equal to 107.5 pMC and 0% being equal to 0 pMC. In another embodiment, the bio-derivable polyhydroxyurethanes has a bio-mass content in the range of 60-85%, according to ASTM-D6866. In another embodiment, the bio-derivable polyhydroxyurethanes has a bio-mass content in the range of 65-92 pMC, according to ASTM-D6866.

An aspect is a composition comprising the bio-derivable polyhydroxyurethane, as disclosed hereinabove. The composition may further include one or more additives selected from the group consisting of tackifiers, plasticizers, viscosity modifiers, photoluminescent agent, anti-counterfeit and UV-reactive additives, dyes/pigments, anti-static materials, surfactants, and lubricants. The one or more additives may be present in an amount of less than 10 wt. %, or less than 5 wt. % or less than 1 wt. %, based on the total weight of the composition.

In an embodiment, the composition comprises the bio-derivable polyhydroxyurethane derived from a monomer and one or more polymerizable amine crosslinkers. In another embodiment, the composition comprises the bio-derivable polyhydroxyurethane derived from lignin-derivable cyclic carbonate monomer and the non-lignin-derived cyclic carbonate comonomer, and the one or more polymerizable amine crosslinkers.

Another aspect is an article comprising the composition as disclosed hereinabove. In an embodiment, the article is a coated surface. In another embodiment, the article is a packaging. In yet another embodiment, the article is a rigid foam or a flexible foam. In some embodiments, the article is an elastomer, an artificial leather, a composite wood product, or a fiber-reinforced composite. In other embodiments, the article is an underwater cable, a microelectronic component, or a printed circuit board. In yet some other embodiments, the composition is an adhesive, or a sealant.

As used herein, when an amount, concentration, or other value or parameter is given as either a range, preferred range, or a list of upper preferable values and lower preferable values, this information is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the compositions or processes. Additionally, in some embodiments, the invention can be construed as excluding any element or process step not specified herein.

### EXAMPLES

Examples of the present invention will now be described. The technical scope of the present invention is not limited to the examples described below.

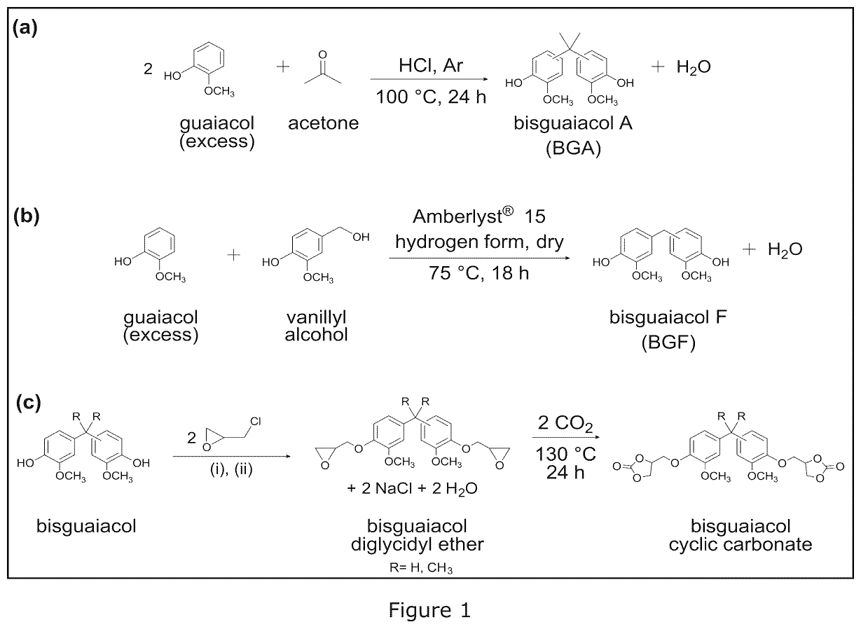

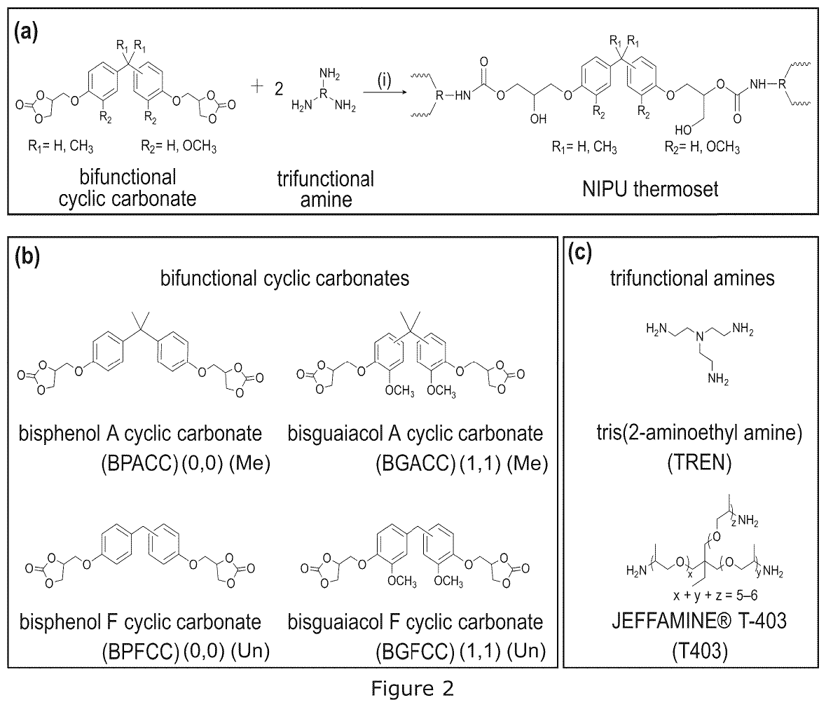

Herein, the thermomechanical properties of a series of lignin-derivable NIPU thermosets are explored. Specifically, the impact of structural differences (e.g., the number of methoxy groups on the aromatic rings and bridging-carbon substitutions in the lignin-derivable monomers) on T_{g}, thermal stability, modulus, σ_{y}, toughness, and ε_{b} are probed. For this study, bio-derivable bisguaiacols with methoxy groups on the aromatic rings were functionalized to form diglycidyl ethers and then dicyclic carbonates (Scheme 1 in FIG. 1). The behavior of these lignin-inspired materials was benchmarked against petroleum-derived analogues generated from BPA and BPF. The various cyclic carbonates were cured by two different amines, TREN (short-chain triamine) and JEFFAMINE® T-403 (T403, long-chain, flexible, polyether triamine), to assess structure-property relationships of both tightly and loosely crosslinked NIPU networks (Scheme 2 in FIG. 2). Using this approach, the thermomechanical versatility of the lignin-derivable NIPU thermosets became apparent, in which the mechanical properties, in particular the toughness, were significantly enhanced in comparison to the petroleum-based benchmarks, while the advantageous thermal properties were retained.

### Materials

Materials and their source are listed below:

BADGE (molecular weight=340.41 g/mol, extent of oligomerization=about 0.02, physical form=solid), guaiacol (≥98% food grade), vanillyl alcohol (≥98%), thioglycolic acid (98%), and Amberlyst® 15 hydrogen form (dry) were purchased from Sigma-Aldrich. Bisphenol F diglycidyl ether (BFDGE, EPON™ 862, epoxy equivalent weight=170 g/mol), a product of Hexion was purchased through Chemical Marketing Concepts Inc. T403 (molecular weight=about 440 g/mol), a product of The Huntsman Corporation, was supplied by Azelis Americas CASE. Tetrabutylammonium bromide (TBAB, 99+%), epichlorohydrin (99%), and deuterated dimethyl sulfoxide (DMSO-d6) were purchased from Acros Organics. TREN (97%), acetone (≥99.5%), hydrochloric acid (HCl, 36.5 to 38.0% [w/w]), sodium hydroxide (≥97%), N,N-dimethylformamide (DMF, ≥99.8%), magnesium sulfate (anhydrous), sodium bicarbonate (≥99.7%), sodium chloride (≥99.5%), dichloromethane (DCM, ≥99.5%), hexanes (99%), ethyl acetate (≥99.5%), acetonitrile (≥99.9%) and chloroform (>99.8%) were purchased from Thermo Fisher Scientific. All chemicals were used as received. Carbon dioxide (CO₂, grade 5), argon (Ar, grade 5), and nitrogen (N2, grade 5) were purchased from Keen Compressed Gas.

### Methods

### NMR Spectroscopy

All NMR samples were prepared in DMSO-d₆, and spectra were recorded on a Bruker AVANCE III 600 MHz spectrometer. ¹H NMR spectra were processed and evaluated using the MestReNova software package.

### Mass Spectrometry

The masses of bisguaiacols, diglycidyl ethers, and cyclic carbonates were determined by ESI-FTMS using a Q-Exactive Orbitrap (Thermo Fisher Scientific) mass spectrometer. Samples were dissolved in acetonitrile at a concentration of 0.1 mg/mL, and the ESI-FTMS was conducted in a positive ion mode by direct syringe injection of samples in the mass spectrometer.

### Attenuated Total Reflectance-Fourier Transform Infrared (ATR-FTIR) Spectroscopy

ATR-FTIR spectroscopy was performed using a Thermo Nicolet NEXUS 870 FTIR with deuterated triglycine sulfate/potassium bromide (DTGS/KBr) detector. All cyclic carbonates and non-isocyanate polyurethane (NIPU) network films were scanned at a resolution of 4 cm⁻¹, and 64 scans were collected in the range of 4000-500 cm⁻¹. NIPU formation was assessed by examination of the cyclic carbonate carbonyl stretching band at approximately 1790 cm⁻¹, the urethane carbonyl stretching band at approximately 1700 cm⁻¹, and the broad hydroxyl stretching band at approximately 3500-3300 cm⁻¹.

### Soxhlet Extraction

The gel content of crosslinked NIPU networks was determined through Soxhlet extraction. A representative sample of each NIPU network film (approximately 60 mg) was weighed and placed in a cellulose extraction thimble (obtained from Whatman). The sample-containing thimble was then placed in a Soxhlet extractor. Chloroform (about 100 mL) was used as the extraction solvent, and one cycle of thimble filling and emptying took about 10-12 min. The Soxhlet extraction was done for 24 h at 80° C. with about 140 cycles of filling and emptying of the thimble. The sample was then dried in a vacuum oven at 80° C. until a constant dried weight was obtained (about 48 h). The gel content was estimated by m_{dry}/m₀, for which m_{dry} and m₀ are the weights of the dried sample and the sample before Soxhlet extraction, respectively. Three measurements were performed for each sample, and the reported values are the average gel content with errors representing the standard deviations.

### Differential Scanning Calorimetry (DSC)

A TA Instruments Discovery Series DSC instrument was employed to characterize the T_{g}s of the NIPU networks. Each sample was encapsulated in a Tzero aluminium pan and sealed using a Tzero lid. Two heating/cooling cycles were performed between −20 and 200° C. under a continuous N₂ flow (50 mL/min) at a heating/cooling rate of 10° C./min. Midpoints of the inflections in the second heating traces were used to determine the T_{g}. The reported T_{g} values are an average of three repeats with errors representing the standard deviations.

### Thermogravimetric Analysis (TGA)

A Discovery Series Thermogravimetric Analyzer TA Q500 (TA Instruments) was used to assess the thermal stability of the NIPU networks. Approximately 4-5 mg of each sample was placed in a 100 μL platinum pan, and a continuous flow of N₂ (50 mL/min) was passed over the sample and balance pans. The samples were first heated to 160° C. at a heating rate of 10° C./min and held at this temperature to facilitate residual solvent/moisture removal. The samples were cooled to 25° C. and then heated to 700° C. at a rate of 10° C./min. For the reported TGA traces, the weight loss of each sample was normalized to its weight after the 160 ° C. isothermal hold. The temperature at 5 wt % loss (T_{d,5%}) was used to gauge the thermal stability of crosslinked NIPU films. The reported values are an average of three repeats with errors representing the standard deviations.

### Dynamic Mechanical Analysis (DMA)

A TA Instruments RSA-G2 instrument was used to determine the storage modulus (E′), loss modulus (E″), and tan δ (E″/E′) of various specimens. Rectangular samples with dimensions of 30 mm×10 mm×0.15-0.2 mm (length×width×thickness) were first heated from −10° C. to 150° C., then cooled back to −10° C., followed by a second heating cycle to 150° C., all at a heating/cooling rate of 3° C./min. Data from the second heating trace were used for analysis and are reported herein. The tests were conducted under oscillatory tension mode with a strain amplitude of 0.3%, grip-to-grip separation of about 10 mm, frequency of 1 Hz, and an axial force of 0.4 N. The reported moduli and tan 8 values are an average of three independent repeats with errors representing the standard deviations.

### Tensile Tests

The tensile properties of NIPU networks were measured on a Zwick/Roell tensile tester with a load cell of 100 N and a clamp force of 200 N at about 20° C. Dog-bone-shaped samples were cut from the NIPU network films using a Zwick/Roell bent-lever manual cutting press (ZCP 020). The specimens with dimensions of 9.5 mm×2.5 mm×0.15-0.2 mm (grip-to-grip separation×width×thickness) were subjected to an extension rate of 10 mm/min until film breakage. The tensile strength at yield (σ_{y}), elongation at break (ε_{b}), Young's modulus (E₀), and toughness (area under the tensile stress-strain curve) results are reported as the average values of five specimens with errors representing the standard deviations.

### Synthesis of Bisguaiacol A (BGA)

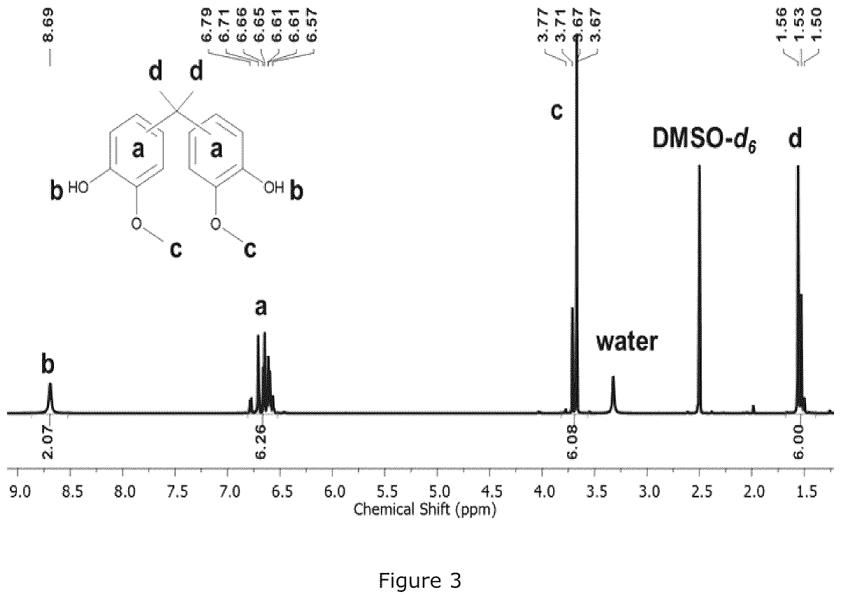

BGA was prepared by the acid-catalyzed condensation of guaiacol and acetone (Scheme 1a) in a manner similar to the previously disclosed approach for the synthesis of BPA (US Publication No. 2022/0251300 A1). In a typical BGA synthesis, 40 g (0.32 mol) of guaiacol, and 3.4 mL (0.046 mol) of acetone (dried over magnesium sulfate) were weighed in a 250-mL, single-neck, round-bottom flask equipped with a condenser and magnetic stir bar. Next, 4 mL of concentrated HCl (4 g, about 15% w/w relative to guaiacol) was slowly added to the above reactants, followed by the addition of 0.17 mL of thioglycolic acid. The reaction mixture was purged with Ar for 10 min and subsequently stirred at 100° C. under reflux for 24 h. Later, the solution was allowed to cool to about 20° C. and then dissolved in 15 mL of DCM. The mixture was washed three times with saturated sodium bicarbonate solution in a separatory funnel. The organic phase was washed three times with deionized (DI) water followed by three washes with brine solution. The residue was purified by automated flash column chromatography (Biotage® Selekt, Sfär Silica column—60 μm particle size, 100 Å pore size, 100 g silica gel) with a step gradient of ethyl acetate (25% v/v) and hexanes (75% v/v) for elution. The solvents were removed from the product by rotary evaporation, after which, the concentrated product was dried in an oven under vacuum at 50° C. for 24 h. The desired product obtained was a white solid (purity: >99%, yield: about 40 mol %). Proton (¹H) Nuclear Magnetic Resonance (NMR) (600 MHZ, DMSO-d₆) δ 8.70 (s, 2H), 6.79 (dd, J=8.5, 2.7 Hz, 0H), 6.71 (t, J=3.5 Hz, 2H), 6.69-6.49 (m, 4H), 3.72 (s, 1H), 3.68 (d, J=2.4 Hz, 4H), 2.51 (s, 5H), 1.55 (d, J=18.2 Hz, 5H). Fourier Transform Mass Spectrometry (FTMS) (Electrospray ionization [ESI], m/z): calcd for C₁₇H₂₀O₄ 288.1362; found 288.1354. The ¹H NMR spectrum with peak assignments is in FIG. 3.

### Synthesis of Bisguaiacol F (BGF)

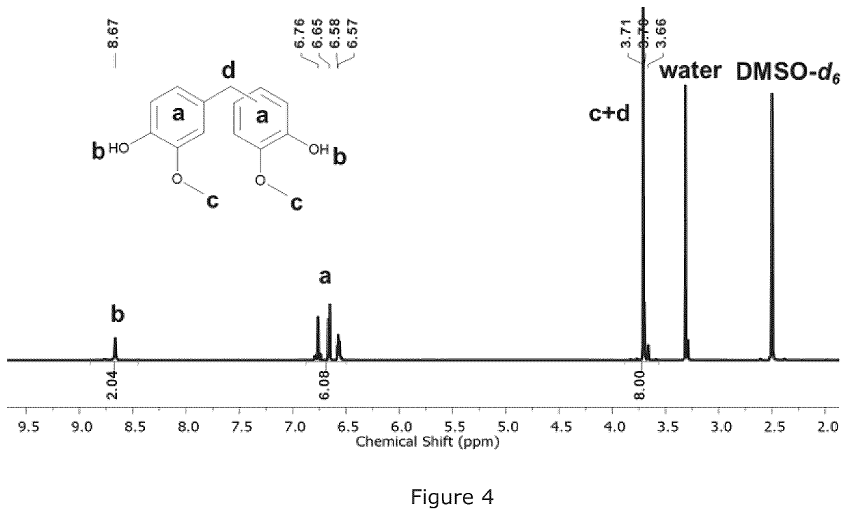

BGF was synthesized by the electrophilic aromatic substitution reaction between vanillyl alcohol and guaiacol (Scheme 1b) as described in the literature (U.S. Pat. No. 10,723,684 B2 (“'684”)) In a typical synthesis of BGF, guaiacol (0.32 mol, 40 g) and vanillyl alcohol (0.08 mol, 12 g) were weighed into a 250-mL, single-neck, round-bottom flask equipped with a magnetic stir bar ('684). The mixture was heated at 75° C., stirred, and sparged with Ar for 40 min. Subsequently, a solid catalyst, dry Amberlyst® 15 hydrogen form (3.6 g, 30% w/w relative to vanillyl alcohol) was added to the reaction mixture. The reaction was allowed to proceed for 16 h. The reaction mixture was then cooled to about 20° C., dissolved in about 40 mL of DCM, and the catalyst was removed using a Büchner funnel equipped with Whatman filter paper (grade 1). The filtrate was washed three times with about 40 mL of DI water in a separatory funnel. Excess DCM from the organic phase was removed by rotary evaporation, and the residue was further purified by automated flash column chromatography (Biotage® Selekt, Sfär Silica column—60 μm particle size, 100 Å pore size, 100 g silica gel) with a step gradient of ethyl acetate (25% v/v) and hexanes (75% v/v) for elution. Solvents were removed from the product by rotary evaporation, after which, the concentrated product was dried in an oven under vacuum at 50° C. for 24 h to give BGF as a white solid (purity: >99%, yield: about 40 mol %). ¹H NMR (600 MHZ, DMSO-d₆) δ 8.67 (s, 2H), 6.87-6.50 (m, 6H), 3.71 (d, J=7.0 Hz, 8H). FTMS (ESI, m/z): calcd for C₁₅H₁₆O₄ 260.1049; found 260.1041. The ¹H NMR spectrum with peak assignments is in FIG. 4.

### General Procedure for the Synthesis of Diglycidyl Ethers

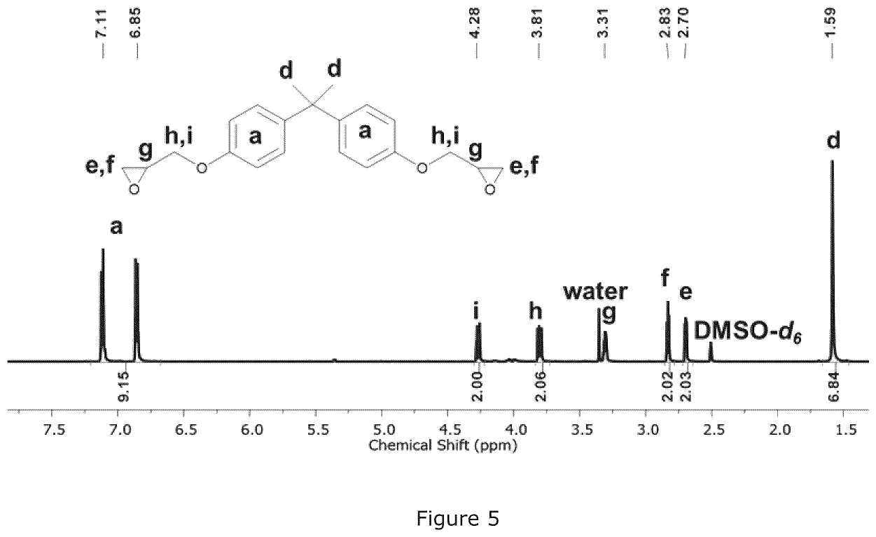

Bisguaiacol diglycidyl ethers were synthesized as described in Nicastro. In a typical synthesis of a diglycidyl ether, epichlorohydrin (0.20 mol), BGA or BGF (0.02 mol), and TBAB (0.002 mol) were weighed into a 50-mL, single-neck, round-bottom flask equipped with a magnetic stir bar. The mixture was stirred, sparged with Ar for 30 min at about 20° C., and then heated at 50° C. for 2 h in an oil bath. The reaction flask was immediately cooled in an ice bath (about 0° C.) for 10 min. The flask was then transferred to a water bath (maintained at about 20° C., and 40 wt % of aqueous NaOH (0.08 mol) was added dropwise to the reaction mixture. The reaction was continued for 16 h at about 20° C. After completion, the reaction mixture was dissolved in about 10 mL of DCM, washed with DI water in a separation funnel until the aqueous layer reached neutral pH, and then washed three times with brine. The organic phase was purified by automated flash column chromatography (Biotage® Selekt, Sfär Silica column-60 μm particle size, 100 Å pore size, 100 g silica gel) with a step gradient of ethyl acetate (60% v/v) and hexanes (40% v/v) for elution. The solvents were removed from the product using a rotary evaporator, after which, the concentrated product was dried in an oven under vacuum at 45° C. for 24 h. The ¹H NMR spectra of all the diglycidyl ethers with peak assignments are in FIGS. 5-8 and summarized below.

### BADGE (Purchased)

¹H NMR (600 MHZ, DMSO-d₆) (FIG. 5): δ 7.21-6.67 (m, 9H), 4.27 (dd, J=11.3, 2.7 Hz, 2H), 3.80 (dd, J=11.4, 6.5 Hz, 2H), 2.83 (dd, J=5.1, 4.2 Hz, 2H), 2.70 (dd, J=5.1, 2.7 Hz, 2H), 1.58 (d, J=3.9 Hz, 7H). FTMS (ESI, m/z): calcd for C₂₁H₂₄O₄ 340.1675; found 340.1744.

### Bisguaiacol A Diglycidyl Ether (BGADGE)

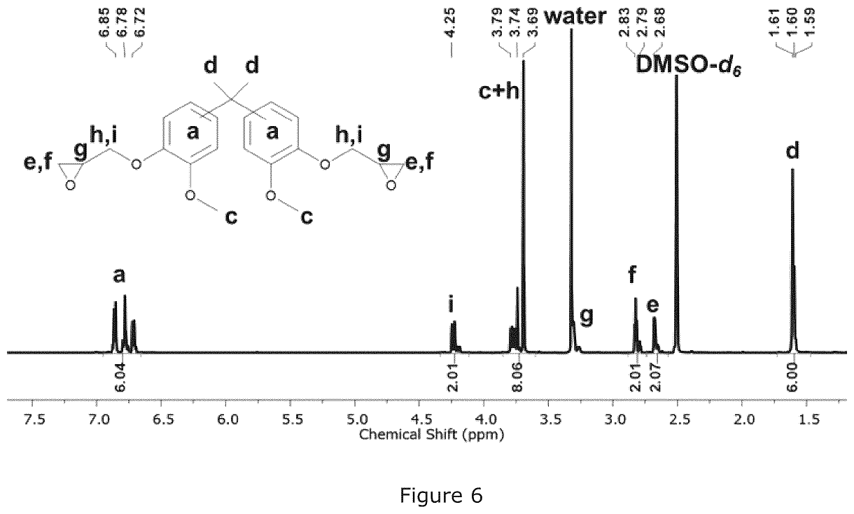

White solid, (purity: >99%, yield: about 80 mol %). ¹H NMR (600 MHZ, DMSO-d₆) (FIG. 6): δ 6.86 (dd, J=8.8, 3.2 Hz, 1H), 6.82-6.59 (m, 2H), 4.22 (ddd, J=24.3, 11.4, 2.8 Hz, 1H), 3.86-3.65 (m, 3H), 3.43-3.17 (m, 3H), 2.81 (dt, J=20.2, 4.9 Hz, 1H), 2.67 (ddd, J=14.0, 5.3, 2.6 Hz, 1H), 1.60 (d, J=7.1 Hz, 2H). FTMS (ESI, m/z): calcd for C₂₃H₂₈O₆ 400.1886; found 400.1951.

### BFDGE (Purchased)

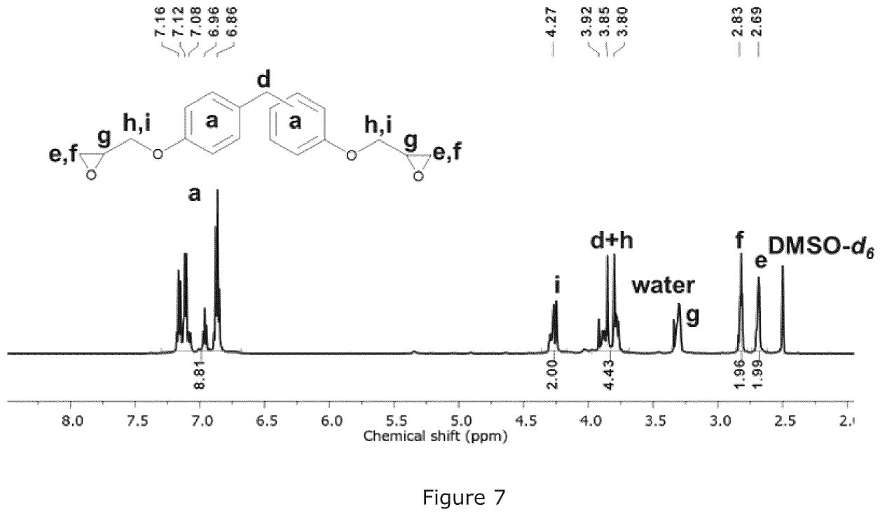

¹H NMR (600 MHZ, DMSO-d₆) (FIG. 7): δ 7.30-6.68 (m, 9H), 4.36-4.17 (m, 2H), 3.97-3.68 (m, 4H), 2.83 (dt, J=9.3, 4.5 Hz, 2H), 2.74-2.62 (m, 2H). FTMS (ESI, m/z): calcd for C₁₉H₂₀O₄ 312.1362; found 312.1444.

### Bisguaiacol F Diglycidyl Ether (BGFDGE)

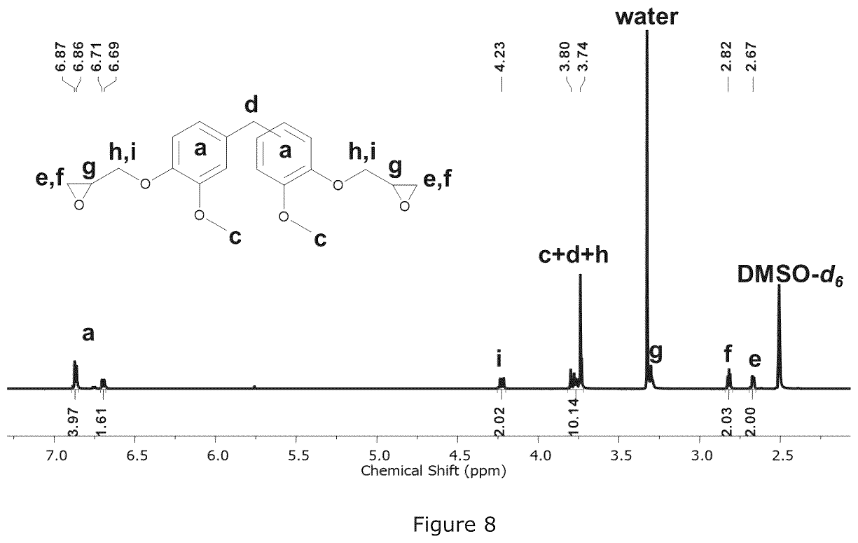

White solid (purity: >99%, yield: about 80 mol %). ¹H NMR (600 MHZ, DMSO-d₆) (FIG. 8): δ 6.89-6.85 (m, 4H), 6.71-6.68 (m, 2H), 4.23 (ddd, J=11.4, 7.2, 2.8 Hz, 2H), 3.82-3.72 (m, 10H), 2.82 (dd, J=5.1, 4.2 Hz, 2H), 2.69-2.65 (m, 2H). FTMS (ESI, m/z): calcd for C₂₁H₂₄O₆ 372.1573; found 372.1574.

### General Procedure for the Synthesis of Cyclic Carbonates

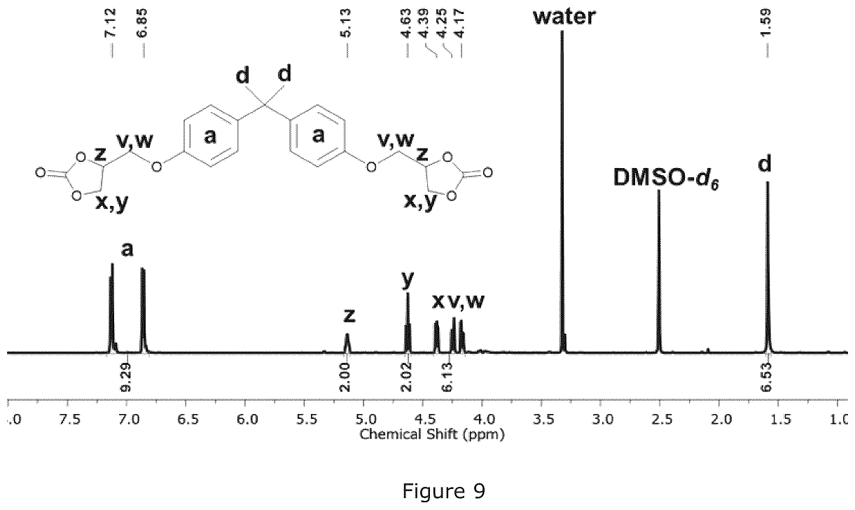

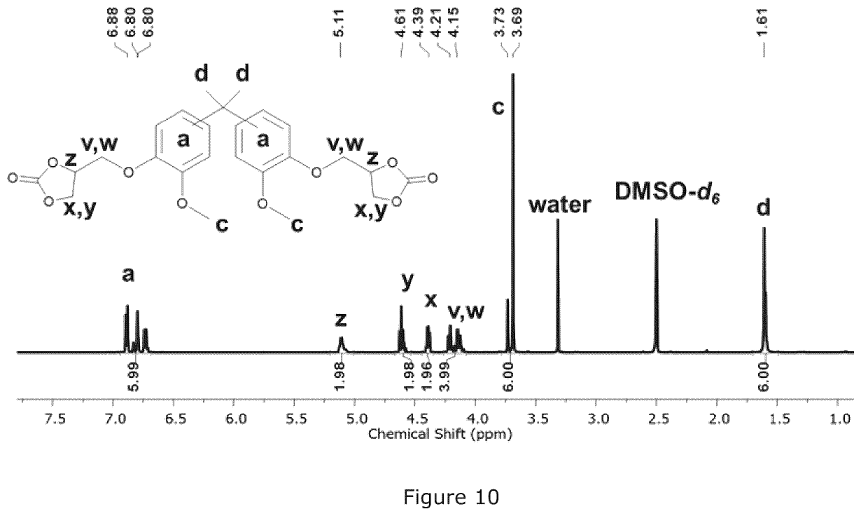

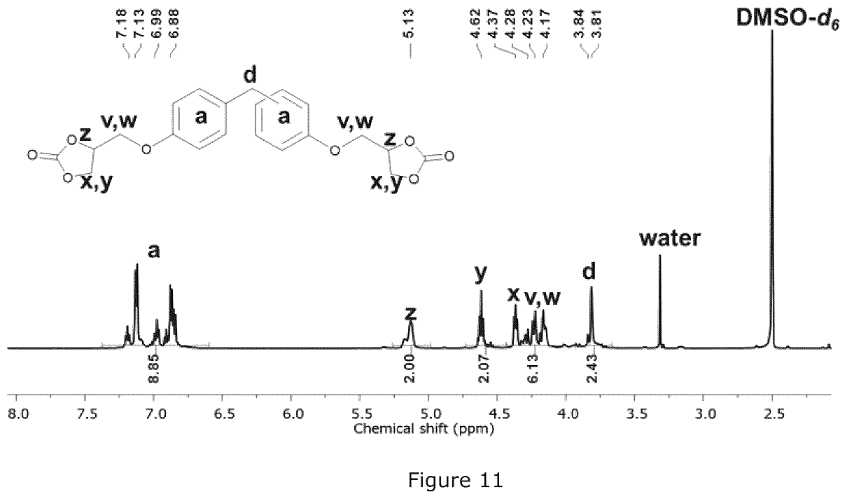

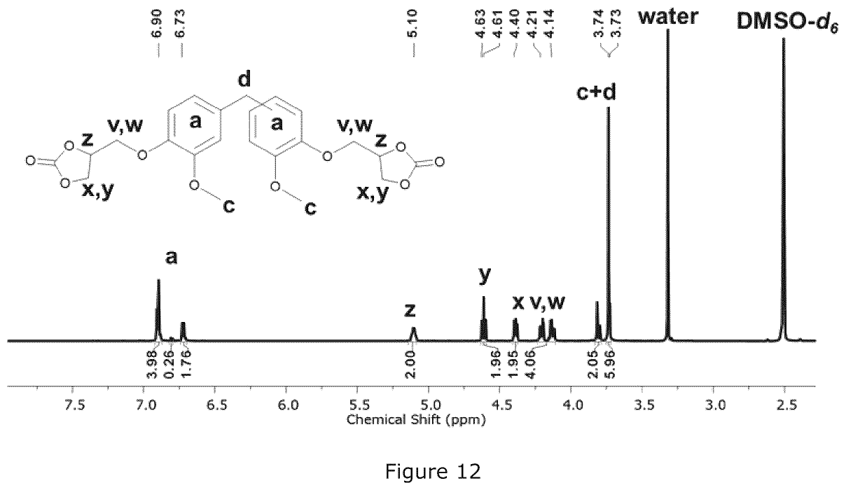

Cyclic carbonates were synthesized by the catalytic carbonation of diglycidyl ethers (Scheme 1c in FIG. 1). In a typical synthesis of bisphenolic cyclic carbonate (using BPACC as an example), BADGE (0.03 mol, 10 g), and TBAB (0.12 g, 1.2% w/w relative to diglycidyl ether) were weighed in a 25-mL Teflon™ cylindrical liner equipped with a magnetic stir bar. The liner was sealed in a 25-mL Parr reactor and purged with CO₂ three times at about 20° C. The reaction mixture was then pressurized with about 20 bar CO₂, heated at 130° C. using a ceramic band heater connected to a proportional-integral-derivative controller, and stirred for 24 h. After the reaction time, the reactor was allowed to cool to about 20° C. and was then depressurized. The resulting product was dissolved in acetone (about 2 mL) and precipitated in DI water (about 20 mL) two times. The precipitated solid was dried in an oven under vacuum at 65° C. for 24 h to afford BPACC. The other cyclic carbonates were synthesized similarly. The ¹H NMR spectra of the cyclic carbonates with peak assignments are in FIGS. 9-12 and summarized below.

### BPACC

White solid (purity: >99%, yield: about 85 mol %). ¹H NMR (600 MHZ, DMSO-d₆) δ 7.17-6.81 (m, 9H), 5.17-5.11 (m, 2H), 4.63 (t, J=8.5 Hz, 2H), 4.41-4.14 (m, 6H), 1.59 (d, J=5.1 Hz, 6H). FTMS (ESI, m/z): calcd for C₂₃H₂₄O₈ 428.1471; found 428.1536.

### Bisguaiacol A Cyclic Carbonate (BGACC)

Beige solid, (purity: >99%, yield: about 85 mol %). ¹H NMR (600 MHZ, DMSO-d₆) δ 6.94-6.69 (m, 6H), 5.20-5.01 (m, 2H), 4.60 (dt, J=13.8, 8.5 Hz, 2H), 4.44-4.35 (m, 2H), 4.26-4.07 (m, 4H), 3.71 (d, J=26.7 Hz, 6H), 1.60 (d, J=6.6 Hz, 6H). FTMS (ESI, m/z): calcd for C₂₅H₂₈O₁₀ 488.1682; found 488.1771.

### Bisphenol F Cyclic Carbonate (BPFCC)

White solid, (purity: >99%, yield: about 85 mol %). ¹H NMR (600 MHZ, DMSO-d₆) δ 7.37-6.59 (m, 9H), 5.26-4.98 (m, 2H), 4.73-4.43 (m, 2H), 4.43-4.02 (m, 6H), 3.93-3.66 (m, 2H). FTMS (ESI, m/z): calcd for C₂₁H₂₄O₈ 400.1158; found 400.1243.

### Bisguaiacol F Cyclic Carbonate (BGFCC)

Beige solid, (purity: >99%, yield: about 85 mol %). ¹H NMR (600 MHZ, DMSO-d₆) δ 6.92-6.87 (m, 4H), 6.72 (td, J=7.7, 7.1, 2.0 Hz, 2H), 5.10 (dddd, J=8.7, 6.3, 4.6, 2.6 Hz, 2H), 4.61 (t, J=8.5 Hz, 2H), 4.41-4.37 (m, 2H), 4.23-4.11 (m, 4H), 3.81 (d, J=12.8 Hz, 2H), 3.73 (d, J=5.6 Hz, 6H). FTMS (ESI, m/z): calcd for C₂₃H₂₄O₁₀ 460.1369; found 460.1443.

### EXAMPLE: PREPARATION OF NIPU THERMOSETS

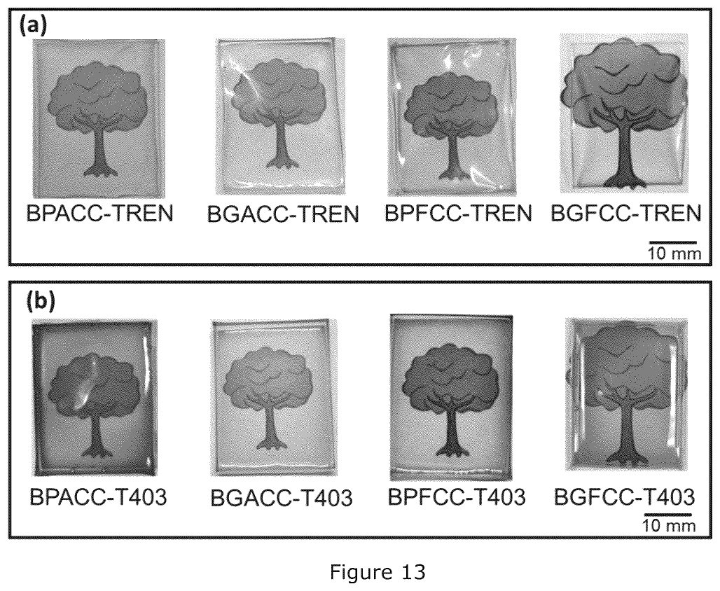

All NIPU networks were prepared by reacting equivalent functional groups of cyclic carbonates and amines (1:0.67 [mol/mol] on a molecule basis). Herein, the cyclic carbonate functionality was determined based on the molecular structures (confirmed by ¹H NMR spectroscopy and mass spectrometry). The high purity (>99%) of cyclic carbonates indicated that the cyclic carbonates are bifunctional. In a typical thermoset preparation as illustrated through the formation of BGACC-TREN networks, 0.6 mmol of BGACC and 0.4 mmol of TREN were dissolved in 1.0 mL and 0.5 mL of DMF, respectively. After solubilization, the solutions of BGACC and TREN were added to a 20 mL scintillation vial and mixed by shaking on a shaker plate at 800 rpm for 20 min. The solution was then poured into a rectangular silicone mold having dimensions of 33 mm×25 mm×16 mm (length×width×height). For uniform and defect-free film formation, the reaction mixture was first cured in air at 60° C. for 2 h, then at 80° C. for 2 h, followed by 100° C. for 20 h. To ensure complete solvent removal and maximum conversion, the sample was postcured at 100° C. for 48 h under vacuum. The other 7 networks with either TREN or T403 were prepared similarly using stoichiometric equivalents (1:0.67 [mol/mol]) of the cyclic carbonates to amines to provide 0.1-0.2-mm-thick NIPU network films (FIG. 13).

### Results and Discussion

Due to the structural similarities between lignin-derivable bisguaiacols and petroleum-derived BPA/BPF, it is believed that the bio-derivable NIPUs are suitable alternatives to petroleum-based NIPU thermosets. Variations in methoxy content and bridging-carbon substitution as dictated through building-block choice can be used to tune thermomechanical properties. Towards these objectives, lignin-derivable BGA was synthesized through the condensation of guaiacol and acetone (Scheme 1a; FIG. 1), and lignin-derivable BGF was synthesized via the acid-catalyzed electrophilic aromatic substitution reaction between guaiacol and vanillyl alcohol (Scheme 1b; FIG. 1). Then, the bisguaiacol diglycidyl ethers were synthesized by glycidylation of BGA and BGF (Scheme 1c; FIG. 1). Carbonation of the diglycidyl ethers generated BGACC and BGFCC, respectively (Scheme 1c; FIG. 1). For comparative purposes, BPACC and BPFCC were prepared using a similar approach. The chemical structure of the respective compounds was confirmed using ¹H NMR spectroscopy, and the molecular weight was determined using mass spectrometry. Thus, the four cyclic carbonates (Scheme 2b; FIG. 2) differed in the number of methoxy groups, with either one methoxy group on each of the aromatic rings (1,1) or no methoxy groups on each ring (0,0). The cyclic carbonates also varied in bridging-carbon substitution (i.e., unsubstituted bridging carbon [Un] or dimethyl-substituted bridging carbon [Me]). The cyclic carbonates were cured by reaction with either a short-chain triamine (TREN) or a long-chain triamine (T403) (Scheme 2c; FIG. 2) to investigate the impact of bisphenol structural features in densely vs. lightly crosslinked networks.

### Preparation of NIPU Thermosets

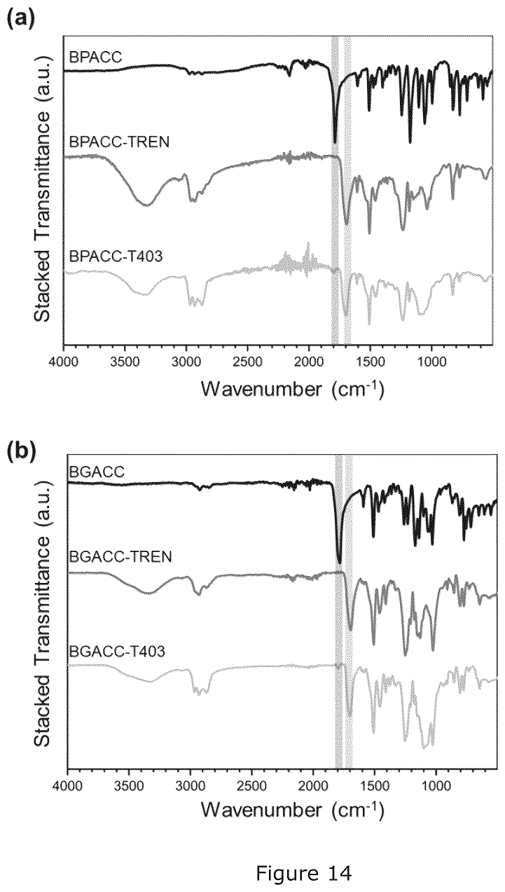

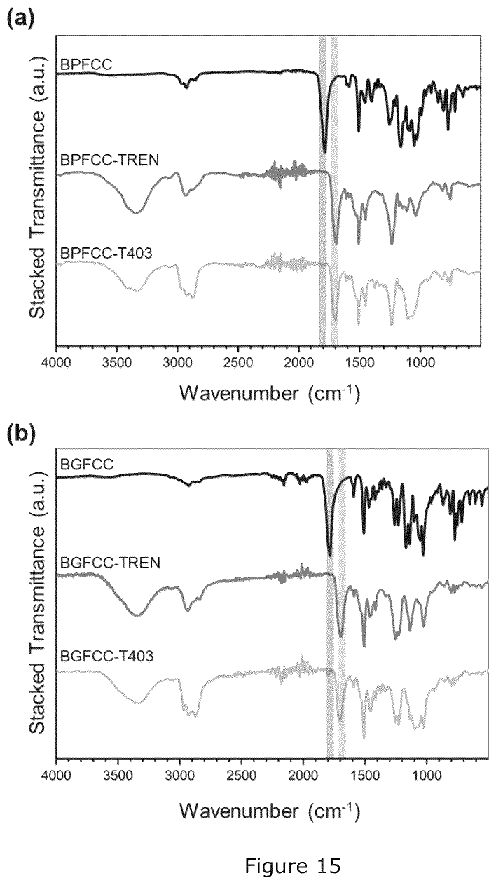

All cyclic carbonates cured with TREN exhibited complete conversion of cyclic carbonate functionalities, within error, as indicated by FTIR data (FIG. 14), in which there is a disappearance of the cyclic carbonate carbonyl stretching band at approximately 1790 cm⁻¹. Additionally, the appearance of urethane carbonyl and hydroxyl stretching bands at approximately 1700 cm⁻¹ and approximately 3300-3400 cm⁻¹, respectively, is noted. The gel contents are provided in Table 1 and also suggest conversions >99%. In contrast, the T403-based networks had a urethane carbonyl stretching band (approximately 1700 cm⁻¹) and hydroxyl stretching band (approximately 3300-3400 cm⁻¹), but they also had a weak absorbance of the cyclic carbonate carbonyl stretching band (approximately 1790 cm⁻¹) (FIG. 15). The gel contents of the T403-cured NIPUs were about 87% in all cases, as shown in Table 1. Without wishing to be bound by any particular theory, it is believed that this lower gel content and incomplete conversion of cyclic carbonates in T403-NIPUs could be a result of the low reactivity of T403, wherein the primary amine group is attached to a secondary carbon in contrast to TREN with the amine group attached to a primary carbon.

TABLE 1
Gel content of NIPU thermosets

| Sample | Gel content (%)^{a, b} |
|---|---|
| BPACC-TREN | 99.4 ± 0.5 |
| BGACC-TREN | 99.2 ± 1.0 |
| BPFCC-TREN | 99.4 ± 0.7 |
| BGFCC-TREN | 99.0 ± 0.5 |
| BPACC-T403 | 87.2 ± 2.8 |
| BGACC-T403 | 86.0 ± 1.3 |
| BPFCC-T403 | 87.5 ± 2.3 |
| BGFCC-T403 | 87.1 ± 1.5 |

^{a}Determined by Soxhlet extraction of NIPU networks at 80° C. with chloroform as an extraction solvent.
^{b}The reported values are the average of three repeats with errors representing the standard deviation.

### Thermal Properties of NIPU Thermosets

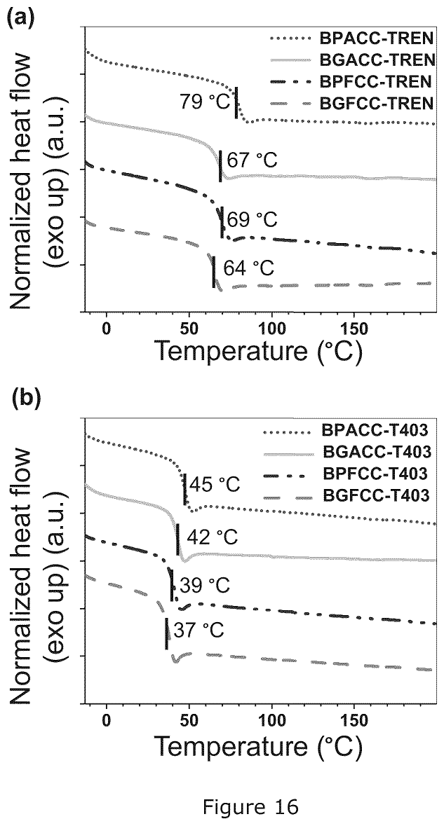

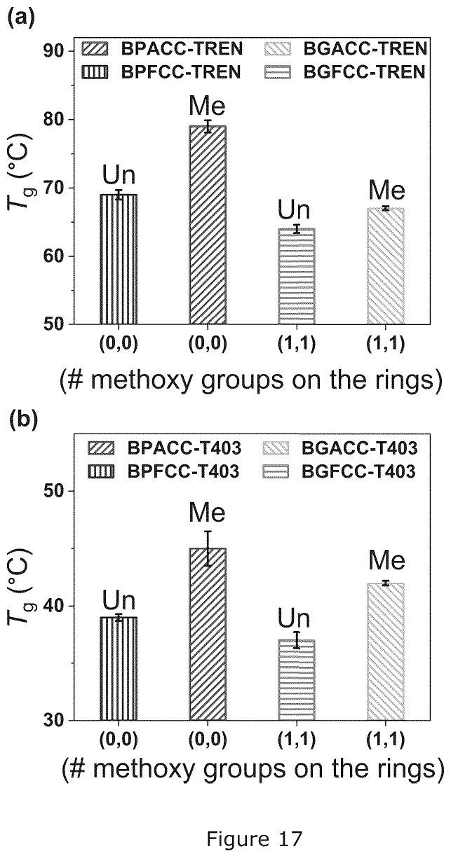

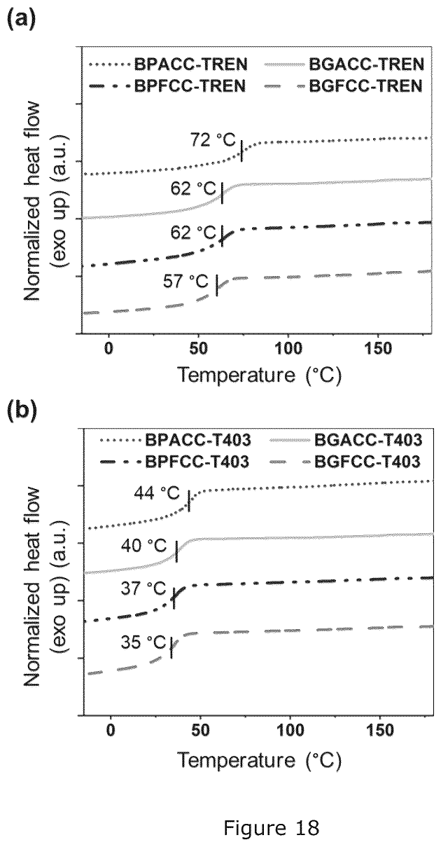

The presence of methoxy groups in lignin-derivable NIPU networks slightly lowered the T_{g}s of the materials as shown in FIGS. 1 and 2. For example, BGACC-TREN had a of about 67° C., and BPACC-TREN had a T_{g} of about 79° C., while BGFCC-TREN had a of about 64° C., and BPFCC-TREN had a T_{g} of about 69° C. (FIGS. 16(a) and 17(a)). A similar trend was noted for the T403-based NIPUs as shown in FIGS. 1b and 2b, though the magnitude of changes was somewhat smaller. This trend in T_{g}s is consistent with the previous literature for lignin-derivable epoxy-amine thermosets (Nicastro, Hernandez, and Nicastro et al., ACS Sustain. Chem. Eng., 2018, 6, 7600-7608 (“Zhao”)), aliphatic/aromatic polyesters and cyanate ester networks (Harvey et al., Macromolecules, 2015, 48, 3173-3179 (“Harvey”)). Interestingly, unlike many NIPUs reported in the literature, there was physical aging noted in both TREN- and T403-cured NIPU thermosets, as indicated by the dips in the DSC heating traces near the T_{g}. However, lignin-derivable and petroleum-derived NIPU networks had comparable physical aging (excess enthalpy values) as shown in FIG. 16 and summarized in Table 2. Furthermore, the T_{g} trend in FIGS. 16 and 17 was consistent with the DSC cooling curves (FIG. 18, Table 2), suggesting that physical aging may not significantly impact the reported T_{g} behavior.

TABLE 2
T_{g} and excess enthalpy values of NIPU thermosets from DSC data

| Sample | Excess enthalpy (J/g)^{a, b} | T_{g} (° C.)^{b, c} |
|---|---|---|
| BPACC-TREN | 0.52 ± 0.15 | 72 ± 0.4 |
| BGACC-TREN | 0.44 ± 0.07 | 62 ± 0.2 |
| BPFCC-TREN | 0.46 ± 0.15 | 62 ± 0.4 |
| BGFCC-TREN | 0.50 ± 0.12 | 57 ± 1.8 |
| BPACC-T403 | 0.52 ± 0.13 | 42 ± 1.7 |
| BGACC-T403 | 0.52 ± 0.03 | 40 ± 0.6 |
| BPFCC-T403 | 0.44 ± 0.07 | 37 ± 0.5 |
| BGFCC-T403 | 0.54 ± 0.01 | 35 ± 0.6 |

^{a}Determined from the magnitude of the area under the peaks associated with physical aging from the second heating traces of DSC at a heating rate of 10° C./min in an N₂ atmosphere.
^{b}The reported values are the average of three repeats with errors representing the standard deviation.
^{c}Determined from the first cooling trace of DSC at a cooling rate of 10° C./min in an N₂ atmosphere.

The nature of bridging-carbon substitution also affected the T_{g}s of NIPU networks. Dimethyl substitution on bridging carbon resulted in higher T_{g}s vs. unsubstitution (FIG. 17). For example, the T_{g}s of BPACC-TREN (about 79° C.) and BGACC-TREN (about 67° C.) were higher than the T_{g}s of BPFCC-TREN (about 69° C.) and BGFCC-TREN (about 64° C.), FIG. 17(a). This increase in T_{g} is likely related to the reduced rotational freedom caused by the dimethyl substituents.⁴⁵ A similar trend existed for the T403-based networks as shown in FIG. 17(b). In general, the T_{g}s of T403-based networks (about 37-45° C.) were lower than the TREN-based networks (about 64-79 ° C.). The T_{g}s obtained from DMA experiments (the temperature at maximum tan δ, Table 3) showed a comparable trend as above.

TABLE 3
T_{g} and tan δ values of NIPU thermosets
from dynamic mechanical analysis (DMA)

| Sample | T_{g} (° C.)^{a, b} | tan δ^{b, c} |
|---|---|---|
| BPACC-TREN | 96 ± 2 | 1.3 ± 0.1 |
| BGACC-TREN | 84 ± 1 | 2.3 ± 0.1 |
| BPFCC-TREN | 88 ± 1 | 2.2 ± 0.1 |
| BGFCC-TREN | 83 ± 1 | 1.9 ± 0.2 |
| BPACC-T403 | 55 ± 0 | 2.2 ± 0.2 |
| BGACC-T403 | 54 ± 1 | 2.6 ± 0.1 |
| BPFCC-T403 | 52 ± 3 | 2.2 ± 0.2 |
| BGFCC-T403 | 51 ± 1 | 2.1 ± 0.2 |

^{a}T_{g} values are the temperature of the maximum tan δ from the second heating trace of DMA experiments conducted in oscillatory film-tension mode at a heating rate of 3° C./min, strain amplitude of 0.3%, frequency of 0.1 Hz, and an axial force of 0.4N.
^{b}The reported values are the average of three repeats with errors representing the standard deviation.
^{c}tan δ values are obtained from the height of the tan δ peaks from the second heating trace of DMA experiments.

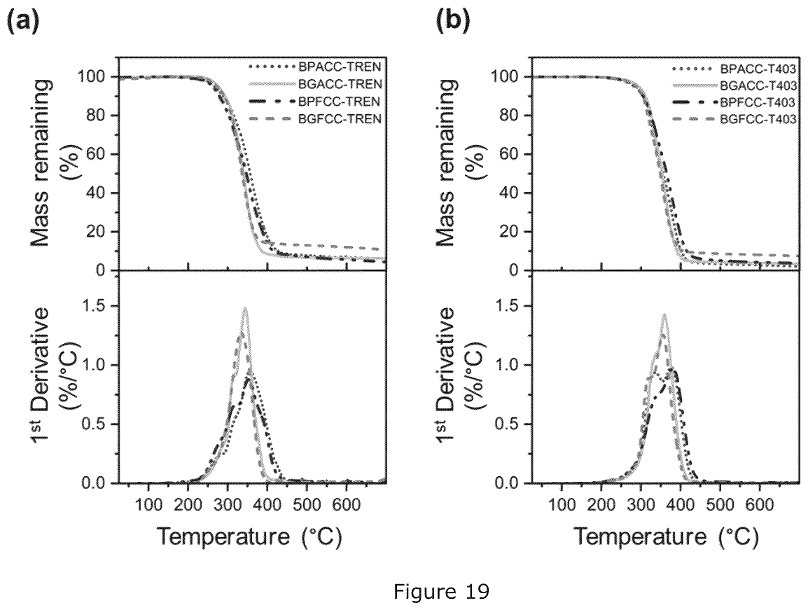

The thermal stabilities and degradation behavior (FIG. 19) of the lignin-derivable NIPU networks were similar to those of the BPA/BPF-based NIPU thermosets. Here, the T_{d,5%} obtained from TGA was used as the comparative metric. The TREN-based networks had T_{d,5%}s between 265° C. and 272 ° C., while the T403-based thermosets had T_{d,5%}s between 286° C. and 298° C. (Table 4). These T_{d,5%} values were comparable with, or even higher than, similar traditional PU systems (T_{d,5%} about 250° C.) (Mahajan et al., ACS Sustain. Chem. Eng., 2020, 8, 15072-15096 (“Mahajan”)). Interestingly, the methoxy groups in the bio-derivable networks did not appear to have a detrimental impact on thermal stability, which is notable because it has been reported that thermal degradation is accelerated by the presence of methoxy groups (Nicastro, Zhao, and Harvey). Additionally, the T403 networks had increased T_{d,5%}s relative to the TREN networks, which is possibly influenced by the longer distance between urethane bonds and the smaller number of such thermally labile urethane linkages per volume in the TREN-based thermoset.

TABLE 4
Thermomechanical properties of NIPU networks

| | T_{g} | T_{d, 5%} | E′₂₅ | E′₁₅₀ | σ_{γ} | Toughness | ε_{b} |
|---|---|---|---|---|---|---|---|
| Sample | (° C.)^{a, b} | (° C.)^{b, c} | (GPa)^{b, d} | (MPa)^{b, d} | (MPa)^{e} | (MJ/m³)^{e} | (%)^{e} |
| BPACC-TREN | 79 ± 0.9 | 265 ± 2 | 1.7 ± 0.2 | 4.4 ± 0.2 | 88 ± 8 | 3 ± 1 | 5 ± 1 |
| BGACC-TREN | 67 ± 0.3 | 272 ± 5 | 1.2 ± 0.2 | 2.5 ± 0.1 | 76 ± 9 | 2 ± 1 | 4 ± 1 |
| BPFCC-TREN | 69 ± 0.7 | 267 ± 5 | 2.1 ± 0.2 | 3.4 ± 0.5 | 72 ± 10 | 3 ± 1 | 7 ± 1 |
| BGFCC-TREN | 64 ± 0.6 | 265 ± 8 | 1.5 ± 0.5 | 4.3 ± 0.5 | 65 ± 8 | 2 ± 1 | 5 ± 1 |
| BPACC-T403 | 45 ± 1.5 | 286 ± 5 | 1.0 ± 0.1 | 1.1 ± 0.2 | 45 ± 2 | 26 ± 8 | 86 ± 26 |
| BGACC-T403 | 42 ± 0.2 | 298 ± 4 | 1.1 ± 0.1 | 1.3 ± 0.2 | 42 ± 3 | 49 ± 6 | 195 ± 8 |
| BPFCC-T403 | 39 ± 0.3 | 287 ± 4 | 1.5 ± 0.3 | 2.0 ± 0.2 | 28 ± 2 | 35 ± 3 | 166 ± 7 |
| BGFCC-T403 | 37 ± 0.7 | 290 ± 10 | 1.2 ± 0.1 | 1.1 ± 0.3 | 28 ± 4 | 59 ± 9 | 278 ± 34 |

^{a}Determined from the second heating trace of DSC at a heating rate of 10° C./min in a N₂ atmosphere.
^{b}The reported values are the average of three repeats with errors representing the standard deviation
^{c}Determined by TGA at a heating rate of 10° C./min in an N₂ atmosphere.
^{d}Determined from the second heating trace of DMA experiments conducted in oscillatory film tension mode at a heating rate of 3° C./min, strain amplitude of 0.3%, frequency of 0.1 Hz, and an axial force of 0.4N.
^{e}All data are based on tensile stress-strain curves obtained from the uniaxial tensile testing using a load cell of 100N, and an extension rate of 10 mm/min at about 20° C. Toughness is calculated from the area under stress-strain curves. The reported values are the average of five repeats with errors representing the standard deviation.

### Mechanical Properties of NIPU Thermosets

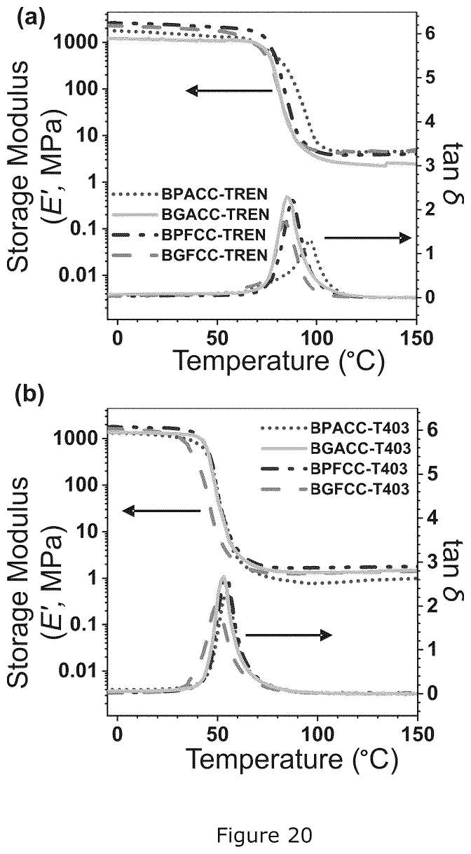

The viscoelastic properties of NIPU thermosets were investigated through DMA and are summarized in Table 4 and Table 3. As illustrated in FIG. 20, the E′ data show a pattern found in a typical thermosetting polymer, (Kinloch et al. in Fracture Behaviour of Polymers, eds. A. J. Kinloch and R. J. Young, Springer Netherlands, Dordrecht, 1995 (“Kinloch”)) with a sharp drop in E′ appearing near the T_{g} followed by a rubbery plateau with no terminal relaxation. The storage moduli at 25° C.(E′₂₅) for the NIPU networks ranged from about 1.0 GPa to 2.1 GPa. These E′₂₅ values are consistent with E₀ values (about 1.2 GPa to 2.2 GPa) obtained from the tensile testing of NIPU networks (Table 5), and they are also comparable to similar traditional PU thermosets (about 1 GPa) (Mahajan). The storage moduli at 150° C. (E′₁₅₀; i.e., the rubbery plateau moduli) ranged from 2.5 MPa to 4.4 MPa for TREN NIPUs, while the E′₁₅₀s of T403 NIPUs were between 1.1 MPa and 2 MPa. The lower E′₁₅₀ values of T403-based networks vs. those of the TREN-based counterparts was likely the result of the higher molecular weight between crosslinks of T403 NIPUs as influenced by T403 chain length.

TABLE 5
Young's modulus (E₀) values of NIPU networks

| Sample | Eₒ (GPa)^{a, b} |
|---|---|
| BPACC-TREN | 2.0 ± 0.3 |
| BGACC-TREN | 2.1 ± 1.3 |
| BPFCC-TREN | 2.0 ± 0.3 |
| BGFCC-TREN | 1.7 ± 0.3 |
| BPACC-T403 | 2.2 ± 0.7 |
| BGACC-T403 | 2.2 ± 1.3 |
| BPFCC-T403 | 1.4 ± 0.6 |
| BGFCC-T403 | 1.2 ± 0.4 |

^{a}Young's modulus was determined from the slope of the initial elastic region in the engineering tensile stress-strain curves. All data are based on tensile stress-strain curves obtained from the uniaxial tensile testing using a load cell of 100N and an extension rate of 10 mm/min at about 20° C.
^{b}The reported values are the average of five repeats with errors representing the standard deviation.

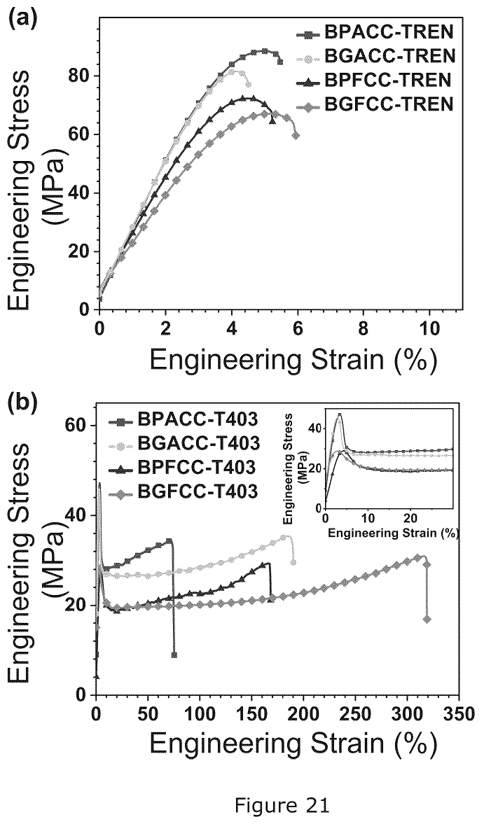

The effect of structural differences in cyclic carbonates and triamines on the tensile properties of NIPU thermosets were examined through uniaxial tensile testing. The TREN-based networks showed elastic deformation and immediate fracture after the yield point, as expected for highly crosslinked thermosets (FIG. 21(a)) (Kinloch). The σ_{y} of all the TREN-based NIPU networks were in the range of 65-88 MPa (Table 4). Though all values are generally within experimental error, FIG. 21(a) substantially suggests that the dimethyl-substituted networks have substantially increased yield strengths vs. their unsubstituted counterparts across both petroleum-based and lignin-derivable constructs.

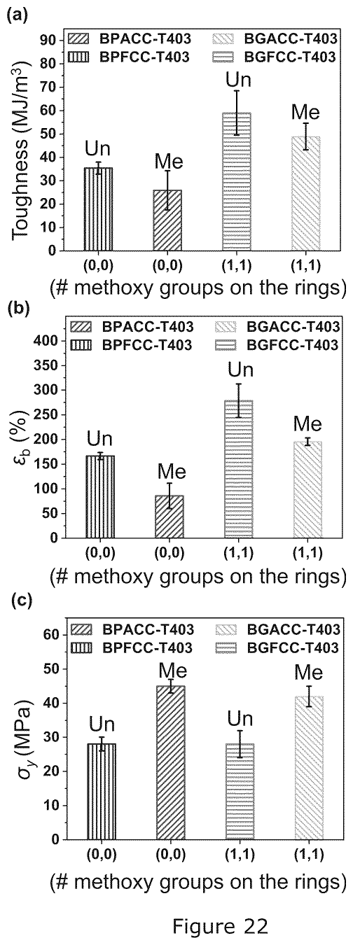

The brittle nature of the TREN-based thermosets provided limited insights into the impact of methoxy groups and bridging-carbon substitutions on the toughness, σ_{y}, and ε_{b}. In contrast, the lightly crosslinked T403 NIPUs allowed more detailed exploration of the role of these structural variations on mechanical behavior. FIG. 21(b) shows representative tensile stress-strain curves for T403 NIPUs. All T403-NIPU thermosets have similar stress-strain curves with initial elastic behavior followed by plastic deformation after the yield point. Also, T403-cured NIPUs exhibited necking during tensile testing that may have led to a sharp yield point. The plastic deformation and high toughness of T403-based networks are strongly impacted by the flexible polyether aliphatic chain of triamine (Xu et al., ACS Macro Lett, 2022, 11, 517-524 (“Xu”)). Additionally, distinct differences were noted in the tensile properties as a function of methoxy group content and the nature of bridging-carbon substitution (FIGS. 22(a), 22(b), and 22(c)). Surprisingly, the toughness and ε_{b} of lignin-derivable, T403-based NIPU networks were significantly higher than those of the thermosets derived from BPA and BPF analogues. For example, the toughness of lignin-derivable BGFCC-T403 (59±9 MJ/m³) was about 66% higher than that of BPFCC-T403 (35±3 MJ/m³). Also, BGFCC-T403 (ε_{b}=278±34%) was more extensible than the BPFCC-T403 (ε_{b}=166±7%) network. Yet, the σ_{y} values of the two networks were quite comparable (about 28 MPa). Moreover, the water uptake of all the thermoset films (Table 6) were generally comparable, which suggests that moisture uptake may not be the major driver impacting the tensile results. A similar trend occurred in the toughness, ε_{b}, and σ_{y} of BGACC-T403 and BPACC-T403 networks as shown in FIG. 22, suggesting that the bio-derivable BGA and BGF platforms increase toughness and extensibility without sacrificing tensile strength.

As described above, the methoxy groups in lignin-derivable NIPUs led to networks with higher toughness and ε_{b} than the BPA/BPF-analogues without any appreciable reduction in σ_{y} or E₀. These methoxy moieties on the aromatic backbone can hinder close chain packing, 30 which could result in network plasticization and enhanced deformability (ε_{b}). However, such plasticizing effects usually reduce the E₀ and σ_{y}, (Kinloch) which was not the case herein. NIPUs inherently have associating hydrogen bonds between the urethane linkages and the pendant hydroxyl groups (Carre and Dong), and the lignin-derivable versions provide additional inter- and intra-molecular hydrogen-bonding sites via their methoxy substituents, which could increase the hydrogen-bonding potential (Hernandez and Wang et al., Green Chemistry, 2020, 22, 1275-1290). These amplified associations may be responsible for the enhanced tensile strength of the polymers (Xu). Thus, without wishing to be bound by any particular theory, it is believed that a combined effect of less efficient chain packing and increased hydrogen bonding possibly resulted in lignin-derivable NIPUs that were tougher than the petroleum-derived systems. This improved toughness is consistent with a recent study on non-isocyanate thermoplastic polythiourethanes, wherein a bisphenol-S cyclic thiocarbonate was cured by amino-terminated dimer-acid polyamides with varying chain lengths (Xu).

Finally, the bridging-carbon substitution also influenced the tensile properties, wherein the dimethyl substituted materials had enhanced σ_{y} vs. their unsubstituted counterparts (FIG. 22(c)). For instance, the σ_{y} of BGACC/BPACC-T403 (about 42-45 MPa) was about 17 MPa higher than BGFCC/BPFCC-T403 (σ_{y} about 28 MPa). However, the dimethyl substituents reduced the toughness and ε_{b} (FIGS. 22(b) and 22(c)), possibly due to more limited chain mobility in comparison to the unsubstituted versions. This trend also held across networks, and it is further apparent that TREN-based NIPUs had higher σ_{y} but lower extensibility than T403-based NIPU thermosets, most likely due to their densely crosslinked architecture obtained from the short-chain triamine (Table 4).

### Methoxy Groups Increase the Hydrogen-bonding Potential of Lignin-derivable NIPU Thermosets

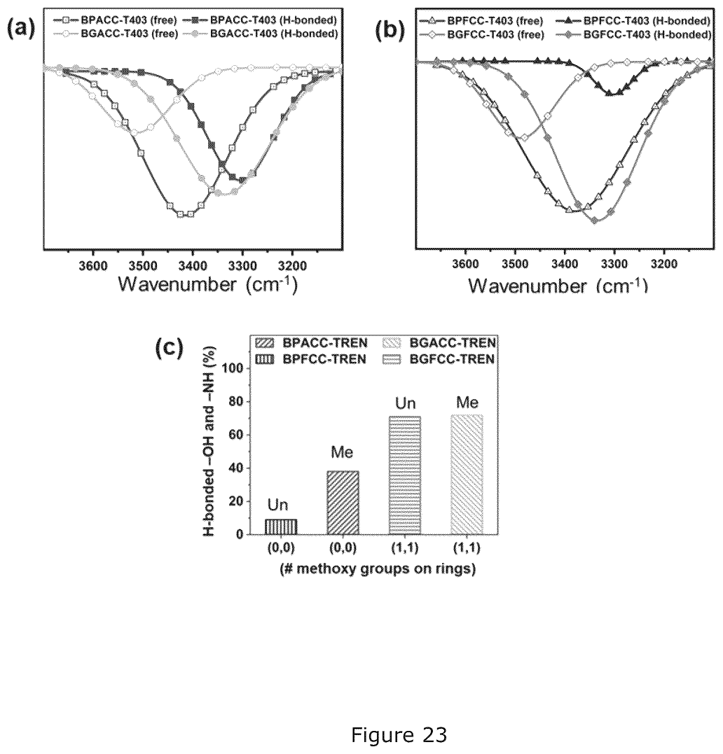

Lignin-derivable NIPU thermosets had improved extensibility compared to the petroleum-derived benchmarks because of the reduced chain packing caused by methoxy groups, resulting in network plasticization (Nicastro). However, such plasticizing effects usually reduce the elastic modulus and yield strength (σ_{y}) (Kinloch). However, no such reduction in tensile properties was noted. Additionally, lignin-derivable NIPUs also had enhanced toughness. This trend could be because of the increased hydrogen bond associations in lignin-derivable systems due to the methoxy groups (Hernandez and Xu). The hypothesis around hydrogen bonding was validated by FTIR spectroscopy. The broad —OH and —NH stretching band (approximately 3100-3600 cm⁻¹) was deconvoluted, wherein the relative amount of free/hydrogen-bonded —OH or —NH in lignin-derivable and petroleum-derived systems were qualitatively compared (FIG. 23). It should be noted that the lignin-derivable NIPUs had relatively more hydrogen-bonded —OH or —NH compared to petroleum-derived analogues.

### CONCLUSIONS

Thus, the above Example shows the effect of structural features in the lignin-derivable cyclic carbonate monomers, such as methoxy content and bridging-carbon substitutions, on the thermomechanical properties of NIPU thermosets. The methoxy groups in the lignin-derivable cyclic carbonate monomers led to NIPU networks with substantially higher toughness (about 49-59 MJ/m³) and ε_{b} (about 195-278%) in comparison to those of BPA/BPF-based benchmarks (toughness about 26-35 MJ/m³, ε_{b} about 86-166%). Moreover, the dimethyl substitution on bridging carbons generated networks with higher σ_{y} (about 45 MPa) than those with unsubstituted bridging carbons (σ_{y} about 28 MPa). This improved mechanical performance of lignin-derivable NIPU thermosets was achieved without any detrimental effects on other crucial thermoset properties such as moduli and thermal stabilities. Furthermore, the T_{g}s of the thermosets are tunable as shown above. In particular, the introduction of methoxy groups lowered the T_{g}s, while the dimethyl bridging carbon substituents raised the T_{g}s, allowing for performance-based optimization. Overall, the structural characteristics, such as methoxy moieties on the rings, the nature of bridging carbon substituents, and/or chain-length of crosslinker, afford thermomechanical versatility to lignin-derivable NIPU networks, highlighting their potential as building blocks in NIPU thermosets.

### ABBREVIATIONS

| | |
|---|---|
| ATR-FTIR | Attenuated total reflectance-Fourier transform infrared |
| BADGE | Bisphenol A diglycidyl ether |
| BFDGE | Bisphenol F diglycidyl ether |
| BGA | Bisguaiacol A |
| BGACC | Bisguaiacol A cyclic carbonate |
| BGADGE | Bisguaiacol A diglycidyl ether |
| BGF | Bisguaiacol F |
| BGFCC | Bisguaiacol F cyclic carbonate |
| BGFDGE | Bisguaiacol F diglycidyl ether |
| BPA | Bisphenol A |
| BPACC | Bisphenol A cyclic carbonate |
| BPF | Bisphenol F |
| BPFCC | Bisphenol F cyclic carbonate |
| DCM | Dichloromethane |
| DI | Deionized |
| DMA | Dynamic mechanical analysis |
| DMF | N, N-dimethylformamide |
| DMSO-d₆ | Deuterated dimethyl sulfoxide |
| DSC | Differential scanning calorimetry |
| DTGS | Deuterated triglycine sulfate |
| E′ | Storage modulus |
| E″ | Loss modulus |
| E′₁₅₀ | Storage modulus at 150° C. |
| E′₂₅ | Storage modulus at 25° C. |
| Eₒ | Young's modulus |
| ESI | Electrospray ionization |
| FTMS | Fourier transform mass spectrometry |
| MDI | Methylene diphenyl diisocyanate |
| Me | Dimethyl-substituted bridging carbon |
| NIPU | Non-isocyanate polyurethane |
| NMR | Nuclear Magnetic Resonance |
| PU | Polyurethane |
| T403 | Jeffamine ® T-403 |
| TBAB | Tetrabutylammonium bromide |
| T_{d, 5%} | Temperature of 5% weight loss |
| TDI | Toluene diisocyanate |
| T_{g} | Glass transition temperature |
| TGA | Thermogravimetric analysis |
| TREN | Tris(2-aminoethyl) amine |
| Un | Unsubstituted bridging carbon |
| ε_{b} | Elongation at break |
| σ_{y} | Tensile strength at yield |

What is claimed:

1. A bio-derivable polyhydroxyurethane comprising in polymerized form:
a) at least one polymerizable lignin-derivable cyclic carbonate monomer having a structure corresponding to formula (I), formula (II), or formula (III): 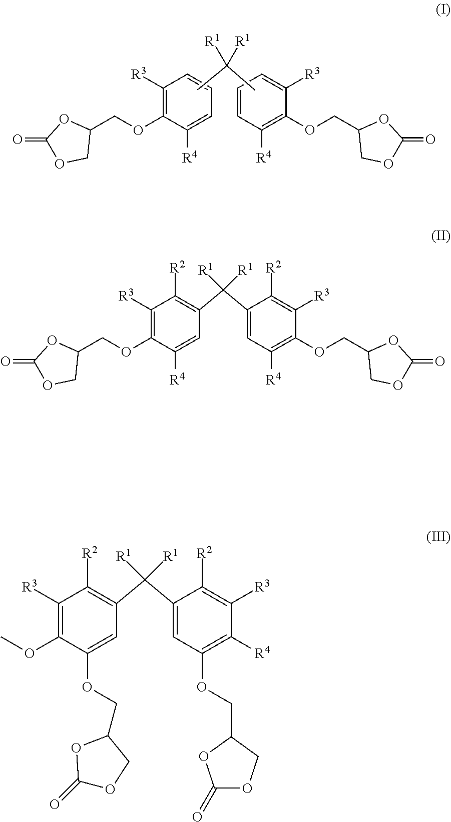
wherein:
(i) each R¹ is independently a hydrogen or a methyl group,
(ii) each R² is independently a hydrogen, a C1-C3 alkyl, a C1-C2 alkoxy, or an allyl group,
(iii) each R³ is independently a hydrogen or a methyl group, and
(iv) each R⁴ is independently a hydrogen, a C1-C3 alkyl, or a C1-C2 alkoxy group; and
(b) one or more polymerizable amine crosslinkers, each comprising two or more primary amines, such that at least one of the one or more polymerizable amine crosslinkers comprises three primary amines.

2. The bio-derivable polyhydroxyurethane according to claim 1, wherein the polymerizable lignin-derivable cyclic carbonate monomer is derived from bisguaiacol A, bisguaiacol F, bisguaiacol P, bisguaiacol S, bissyringol A, bissyringol F, regioisomers thereof, and mixtures thereof.

3. The bio-derivable polyhydroxyurethane according to claim 1, wherein the at least one polymerizable lignin-derivable cyclic carbonate monomer has one of the following structures: 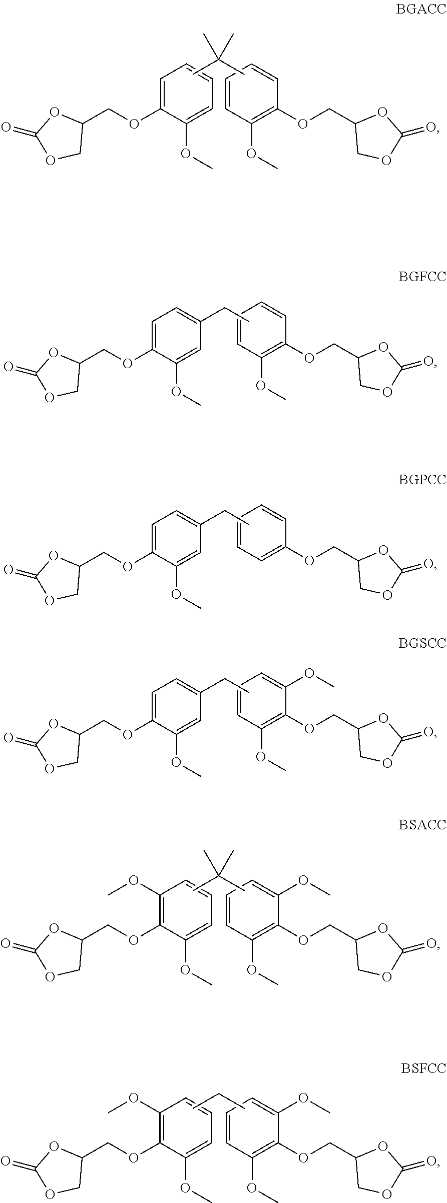 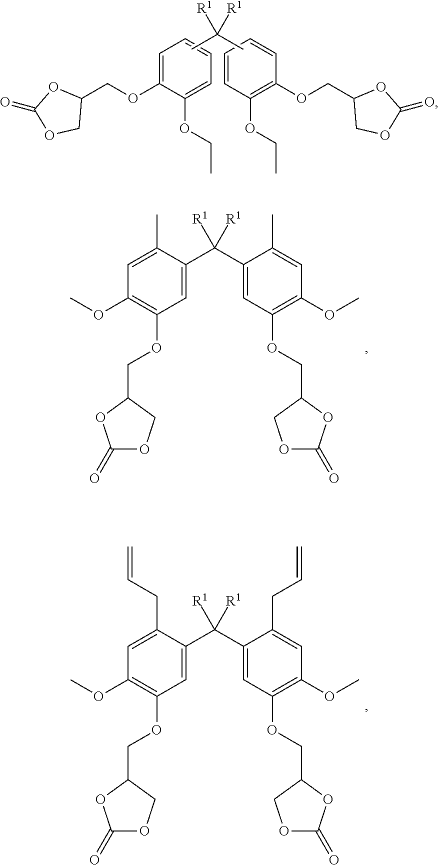
regioisomers thereof, or mixtures thereof,
wherein each R¹ is as defined in claim 1.

4. The bio-derivable polyhydroxyurethane according to claim 1, wherein each of the one or more polymerizable amine crosslinkers independently has a structure corresponding to formula (IV): 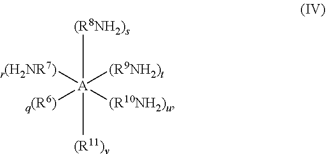
wherein:
(i) A is independently a nitrogen atom, a carbon atom, a phenyl ring, or a cyclohexyl ring,
(ii) each of q, r, s, t, u, and v is independently 0 or 1, such that:
a. if A is a nitrogen atom, a phenyl ring, or a cyclohexyl ring, then q+r+s+t+u+v=3 and r+s+t+u=2 or 3, and
b. if A is a carbon atom, then q+r+s+t+u+v=4, and r+s+t+u=2 or 3 or 4,
(iii) each R⁶ and R¹¹ is independently a hydrogen, a C1-C10 alkyl group, a C4-C9 alicyclic group, or a C5-C50 polyalkylene ether group containing at least one oxygen atom between any two carbon atoms of the alkylene chain, where the alkyl and polyalkylene ether groups can be unbranched or branched,
(iv) each R⁷, R⁸, R⁹, and R¹⁰ is independently a bond (i.e., Co), a C1-C50 alkylene group, a C6-C12 arylene group, a C4-C9 bivalent alicyclic group, or a C5-C50 polyalkylene ether group containing at least one oxygen atom between any two carbon atoms of the alkylene chain, where the alkylene and polyalkylene ether groups can be unbranched or branched.

5. The bio-derivable polyhydroxyurethane according to claim 4, wherein the one or more polymerizable amine crosslinker has one of the following structures: 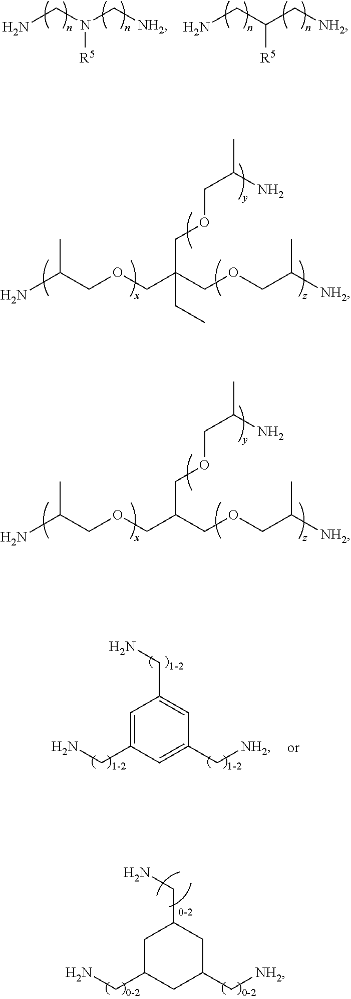
wherein R⁵═H or 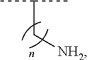
n=1-5, and each of x, y, and z is independently in a range of 1-47, such that x+y+z is in a range of 5-50.

6. The bio-derivable polyhydroxyurethane according to claim 1, wherein the one or more polymerizable amine crosslinkers comprises a mixture of a first polymerizable amine crosslinker comprising three or four primary amine groups and a second polymerizable amine crosslinker comprising two primary amine groups.

7. The bio-derivable polyhydroxyurethane according to claim 1 comprising a portion of a crosslinked structure corresponding to formula (V), formula (VI), or formula (VII): 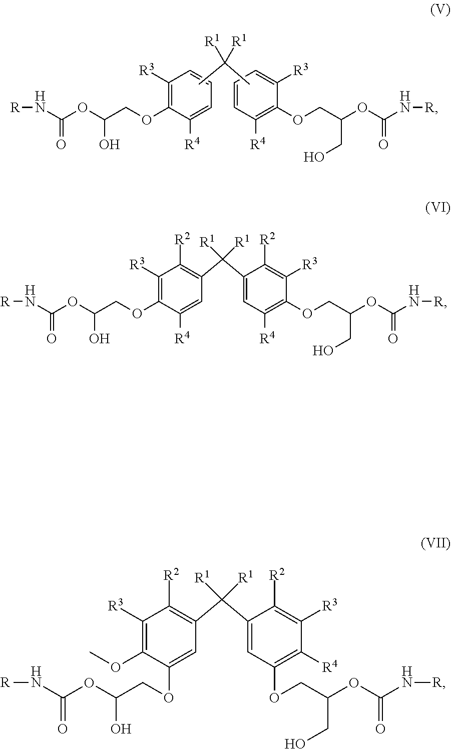
wherein:
(i) each R¹, R², R³, and R⁴ is defined in claim 1,
(ii) each R independently comprises an amine cross-linker containing partially or fully crosslinked amine groups.

8. The bio-derivable polyhydroxyurethane according to claim 7, wherein each —NH—R independently represents a portion of the crosslinked structure, comprising partially or fully crosslinked amine groups of the amine crosslinker, and each —NH—R independently has the following formula (VIII): 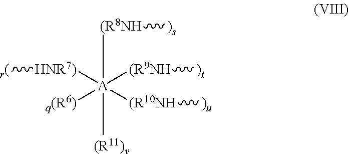
wherein:
(i) A is independently a nitrogen atom, a carbon atom, a phenyl ring, or a cyclohexyl ring,
(ii) each of q, r, s, t, u, and v is independently 0 or 1, such that:
a. if A is a nitrogen atom, phenyl ring, or cyclohexyl ring, then q+r+s+t+u+v=3 and r+s+t+u=2 or 3, and
b. if A is a carbon atom, then q+r+s+t+u+v=4, and r+s+t+u=2 or 3 or 4,
(iii) each R⁶ and R¹¹ is independently a hydrogen, a C1-C10 alkyl group, a C4-C9 alicyclic group, or a C5-C50 polyalkylene ether group,
(iv) each R⁷, R⁸, R⁹, and R¹⁰ is independently a hydrogen, a C1-C10 alkylene group, a C6-C12 arylene group, a C4-C9 bivalent alicyclic group, or a C5-C50 polyalkylene ether group containing an oxygen atom between any two carbon atoms of the alkylene group, and
(v) [symbol] represents where the crosslinked structure (VIII) is either covalently bonded via a NH group to formula (V), formula (VI), or formula (VII), or [symbol] represents covalent bond to hydrogen atom, with the proviso that at least two of R⁷, R⁸, R⁹, and R¹⁰ are bonded such that the bio-derivable polyhydroxyurethane is crosslinked.

9. The bio-derivable polyhydroxyurethane according to claim 1, wherein the bio-derivable polyhydroxyurethane further comprises in polymerized form:
(i) the at least one polymerizable lignin-derivable cyclic carbonate monomer having a structure corresponding to formula (I), formula (II), or formula (III), regioisomers thereof, or mixtures thereof,
(ii) the one or more polymerizable amine crosslinkers each comprising two or more primary amines, each having a structure corresponding to formula (IV), such that at least one of the one or more polymerizable amine crosslinkers comprises three primary amines, and
(iii) a non-lignin-derived cyclic carbonate comonomer.

10. The bio-derivable polyhydroxyurethane according to claim 9, wherein the non-lignin-derived cyclic carbonate comonomer is derived from at least one of 2,2′-diallylbisphenol A, bisphenol A, bisphenol F, bisphenol S, 2,2′-biphenol, 4,4′-biphenol, multiphenol, and/or hydroquinone.

11. The bio-derivable polyhydroxyurethane according to claim 1, wherein the polymerizable lignin-derivable cyclic carbonate monomer and the one or more polymerizable amine crosslinkers are present in a molar ratio of 1:0.5 to 1:1.

12. The bio-derivable polyhydroxyurethane according to claim 1 having (i) a toughness in a range of 0.1 to 25 MJ/m³ and yield strength in a range of 30 to 100 (or more) MPa, or (ii) a toughness in a range of 25 to 100 (or more) MJ/m³ and yield strength in a range of 0.1 to 30 MPa.

13. A composition comprising the bio-derivable polyhydroxyurethane according to claim 1.

14. The composition according to claim 13 further comprising one or more additives selected from the group consisting of tackifiers, plasticizers, viscosity modifiers, photoluminescent agent, anti-counterfeit and UV-reactive additives, dyes/pigments, anti-static materials, surfactants, and lubricants.

15. An article comprising the composition according to claim 14.

16. The article according to claim 15, wherein the article is a coated surface, a packaging, a rigid foam, a flexible foam, an elastomer, an artificial leather, a microelectronic component, an underwater cable, a printed circuit board, a composite wood product, a fiber-reinforced composite, an adhesive, or a sealant.

17. A method of preparing the bio-derivable polyhydroxyurethane according to claim 1, the method comprising:
(i) providing a first solution comprising at least one polymerizable lignin-derivable cyclic carbonate monomer having the structure corresponding to formula (I), formula (II), or formula (III) in a first solvent;
(ii) providing a second solution comprising the one or more polymerizable amine crosslinkers, having a structure corresponding to formula (IV), in a second solvent, wherein each of the one or more polymerizable amine crosslinkers comprises two or more primary amines, such that at least one of the one or more polymerizable amine crosslinkers comprises three primary amines;
(iii) contacting the first solution with the second solution at a temperature in a range of 50 to 110° C. for an amount of time in a range of 16 to 96 h to form the bio-derivable polyhydroxyurethane, wherein the at least one polymerizable lignin-derivable cyclic carbonate monomer and the one or more polymerizable amine crosslinkers are present in a molar ratio of 1:0.5 to 1:1.

18. The method according to claim 17, further comprising post-curing under vacuum at a temperature in the range of 70 to 100° C. for an amount of time in a range of 16 to 96 hours.

19. The method according to claim 17, wherein the first and the second solvent are independently selected from dimethylformamide, 2-methyl tetrahydrofuran, γ-valerolactone, cyrene, dimethylsulfoxide, tetrahydrofuran, and dimethylacetamide.

20. The method according to claim 17, wherein the step of providing a first solution comprises forming the polymerizable lignin-derivable cyclic carbonate monomer comprising the steps of:
(i) contacting an excess molar amount of guaiacol, syringol, or syringyl alcohol with acetone or vanillyl alcohol in the presence of an acid catalyst at a temperature in the range of 60 to 120° C. for an amount of time in a range of 2 to 24 hours to form at least one of bisguaiacol or bissyringol;
(ii) contacting at least one of bisguaiacol or bissyringol with an excess molar amount of epichlorohydrin in the presence of a catalyst to form a diglycidyl ether; and
(iii) carbonating the diglycidyl ether with an excess molar amount of carbon dioxide in the presence of the catalyst at a temperature in the range of 80 to 150° C. and at a pressure of 20 to 30 bar for an amount of time in a range of 12 to 24 hours to form a cyclic carbonate having the structure corresponding to formula (I), formula (II), or formula (III).

21. The method according to claim 20, wherein the catalyst comprises tetrabutylammonium bromide, tetrabutylammonium iodide.
